(19) United States
(12) Patent Application Publication
(10) Pub. No.: US 2011/0186591 A1
(43) Pub. Date: Aug. 4, 2011

(54) ON DEMAND CONSUMABLE PRODUCT HEATING AND/OR COOLING DISPENSER

(76) Inventor: Steve Pfister, Atlanta, GA (US)

(21) Appl. No.: 13/054,727

(22) PCT Filed: Jul. 20, 2009
(86) PCT No.: PCT/US09/04220

§ 371 Date: Apr. 15, 2011

Related U.S. Application Data
(60) Provisional application No. 61/135,286, filed on Jul. 18, 2008.

(51) Int. Cl. G07F 9/10; B65D 83/00

(52) U.S. Cl. 221/97; 221/150 HC

(57) ABSTRACT

An on demand consumable product heating and/or cooling dispenser that relatively quickly adjusts the temperature of a consumable product to a desired temperature is provided. Fluid circulates around the consumable product in a heat transfer device. The heat transfer device controls the motion of the product to maximize heat transfer. The dispenser delivers the product to the heat transfer device, to a storage compartment, and/or to a consumer. The dispenser senses the product temperature and controls the circulation of a fluid until the desired temperature is reached. Also provided is an on demand consumable product heating and/or cooling dispenser that maintains a relatively small queue of consumable product at a desired temperature in an insulated storage device. Consumable product at an ambient temperature is transferred to the insulate storage device as conditioned consumable product is dispenser to the user.

This application claims priority to and the benefit of U.S. Provisional Application No. 61/135,286, filed on Jul. 18, 2008, which application is incorporated in its entirety in this document by reference.

### FIELD OF THE INVENTION

The field of this invention relates generally to the presentation of packaged consumable products and more particularly to cooling and heating consumable products in preparation of potential sales periods.

### BACKGROUND OF THE INVENTION

In order to present to a consumer a ready-to-serve consumable product, such as a can or bottle of soft drink from merchandising equipment, such as a vending machine, the entire inventory of consumable products within the merchandising equipment typically has to be cooled or heated to a ready-to-serve temperature. Cooling or heating the entire inventory of consumable products to the ready-to-serve temperature can take typically take several hours, and can extend up to a full day. Merchandising equipment is refilled with packaged products by delivery personnel or store employees and might not allow sufficient time to bring the products to the desired temperature before a consumer desires to make a purchase. On these occasions, the consumer will be presented with a product that has not yet reached the desired temperature.

Additionally, the actual temperature of the product dispensed by the merchandising equipment can vary greatly based upon the design, condition, location and usage of the equipment. The placement of the consumable product within the equipment can also cause the temperature to vary from the desired temperature.

Furthermore, merchandising equipment is typically not capable of providing a specific product at a specific temperature. Merchandising equipment is typically designed to heat or cool its contents to one specific temperature. As there can be hundreds or thousands of packaged products within the equipment to be heated or cooled, the merchandising equipment is generally designed with the amount of insulation and cooling and/or heating capacity needed to maintain the temperature of hundreds or thousands of packages. This material is significantly more than needed to provide the precise amount of insulation, cooling capacity and/or heating capacity for an individual packaged product.

Moreover, merchandising equipment typically attempts to maintain the desired temperature of the products located within it regardless of sales periods. Thus, the continuous cooling and heating systems can waste significant amounts of energy maintaining the temperature of hundreds or thousands of products that will not be sold for hours or even days. Many store owners turn off the equipment at night to save energy or to avoid overloading circuits, but this however, causes the product located within this equipment to not be at the desired temperature during the sales period that occurs the next day. Additionally, power outages also interrupt equipment operation preventing the desired temperature of consumable products from being maintained.

Conventionally, merchandising equipment is designed such that while dispensing one package, ambient air is allowed to enter the insulated volume. This can alter the temperature of other packages within the merchandising equipment requiring additional energy for the cooling and heating systems to maintain the desired temperature. Additionally, because conventional merchandising equipment design is based on maintaining the temperature of a large volume of product continuously (i.e., 24 hours a day), a large amount of energy is needed to power the equipment.

Still further, a consumer may have a certain temperature at which he prefers to consume beverages or consumable products that is a different preferred temperature for other consumers. Merchandising equipment generally does not allow the consumer to choose their preferred temperature. Instead merchandisers estimate a temperature in a large range that is provided to the consumer. Beverage and food merchandising equipment generally offer hot products only or cold products only. Some merchandising equipment can offer both hot products and cold products; this equipment is generally very expensive and consumes much more energy than standard merchandising equipment.

In view of the preceding, there is a need for merchandising equipment that can adjust the temperature of a consumable product located therein at the time of the sale or on demand.

### SUMMARY

The present application relates to an on demand consumable product heating and/or cooling dispenser and method for using the same, according to various aspects. In various aspects, the on demand consumable product heating and/or cooling dispenser can more efficiently chill or heat a consumable product, and can do so using less energy.

In one aspect, the on demand consumable product heating and/or cooling dispenser comprises means for cooling and/or heating consumable product within a consumer accessible device, such as, for example, a vending machine, to a desired temperature on demand. The means for cooling and/or heating consumable product comprises storing energy in a fluid which is used to transfer energy to or from the consumable product. In another aspect, a standard vapor compression refrigeration cycle can be used to store energy in the fluid. In a further aspect, the dispenser can comprise a heat transfer plate comprising a heat exchanger tube carrying a fluid that can add and/or remove heat to and/or from a consumable product. In yet another aspect, the heat transfer plate can comprise a package clamp that can selectively maintain pressure on the heat exchanger tube and/or conform to the shape of at least a portion of a consumable product package. In various optional aspects, the package clamp can comprise, for example and without limitation, a bellows, an inflatable bladder, or other clamping device.

In another aspect, the on demand consumable product heating and/or cooling dispenser can comprises means for mixing the consumable product to enhance the heat transfer to the composition.

In still another aspect, the on demand consumable product heating and/or cooling dispenser can comprise means for storing consumable products while maintaining the desired temperature. Additionally, in one aspect, the dispenser of the present application can comprise means for dispensing the consumable product to a user at the desired temperature while maintaining the temperature of other packages waiting to be dispensed. In another aspect, the desired temperature can be input by the user, or the desired temperature can be programmed into a control system of the dispenser.

Additional advantages of the invention will be set forth in part in the description which follows, and in part will be obvious from the description, or can be learned by practice of the assembly described according to various aspects herein. The advantages of the assembly will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE FIGURES

These and other features of the preferred embodiments of the invention will become more apparent in the detailed description in which reference is made to the appended drawings wherein:

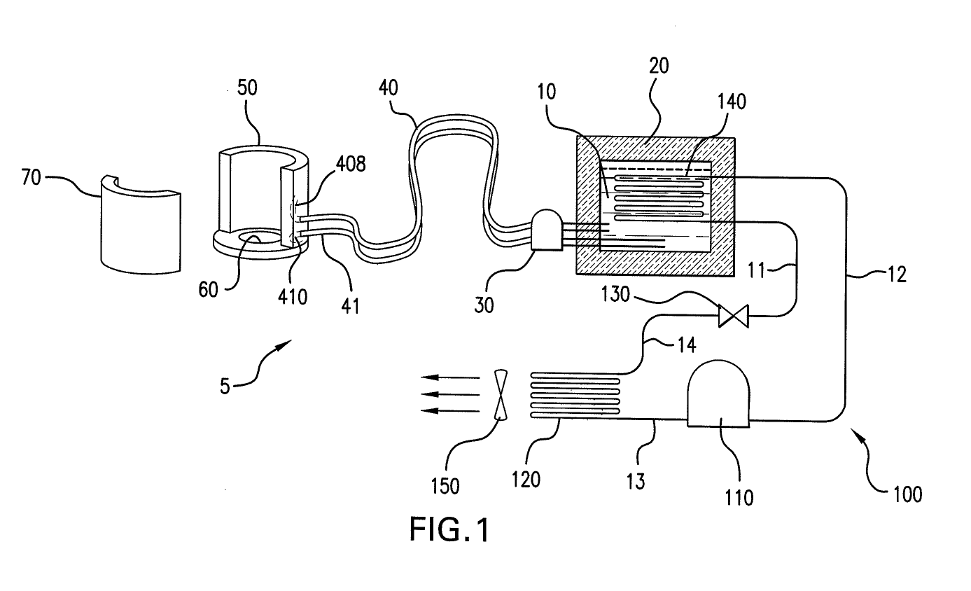

FIG. 1 is a schematic diagram of an exemplary on demand heating and/or cooling dispenser system, according to one aspect.

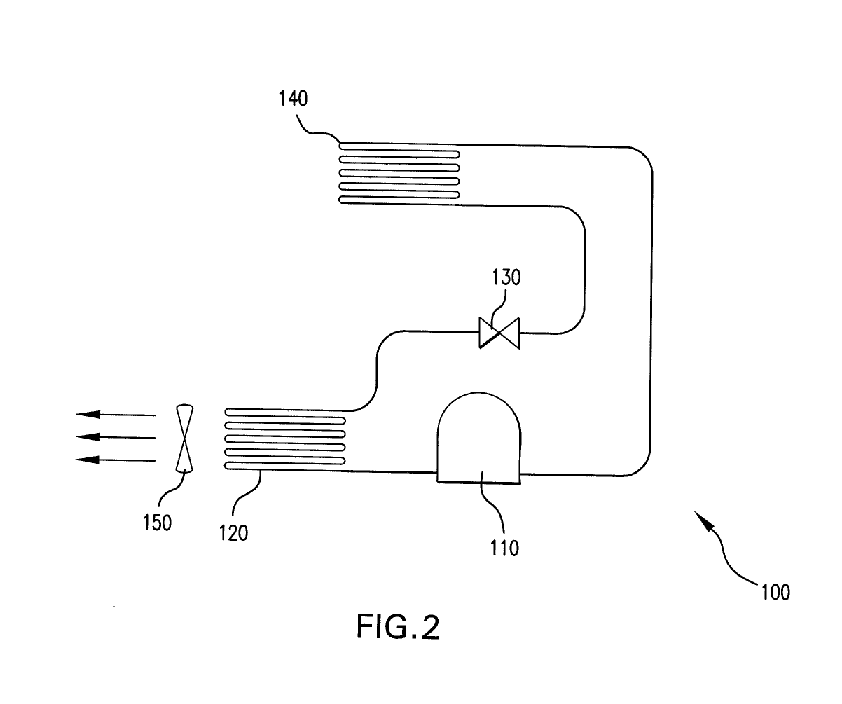

FIG. 2 is a schematic diagram of a conventional vapor compression refrigeration system, according to one aspect.

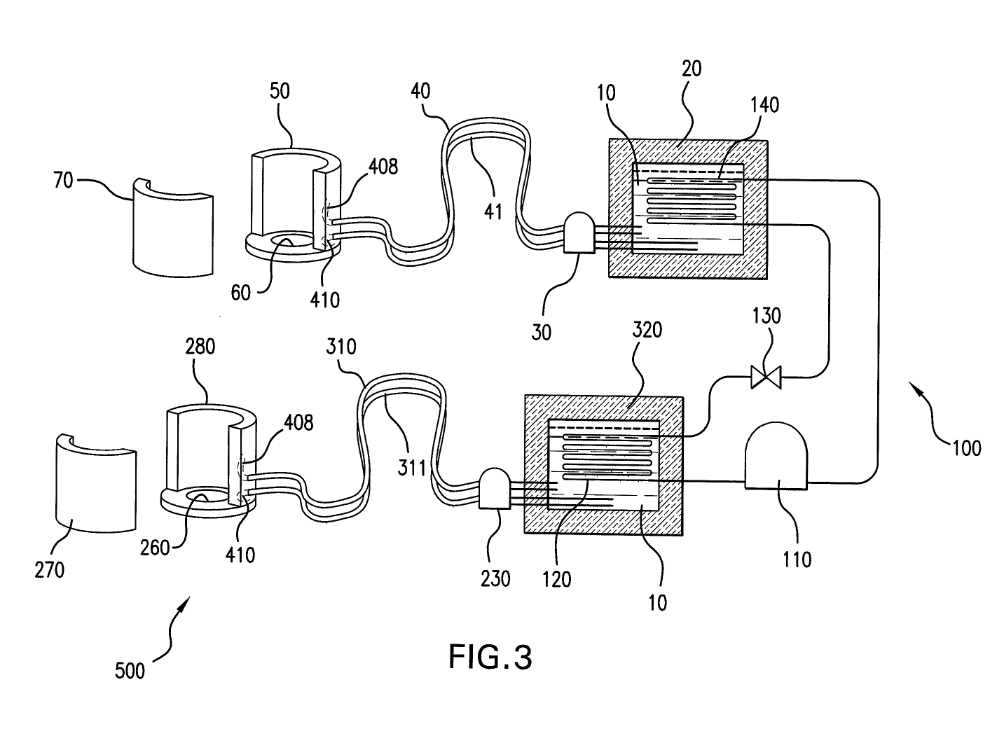

FIG. 3 is a schematic diagram of an exemplary on demand heating and/or cooling dispenser system, according to another aspect.

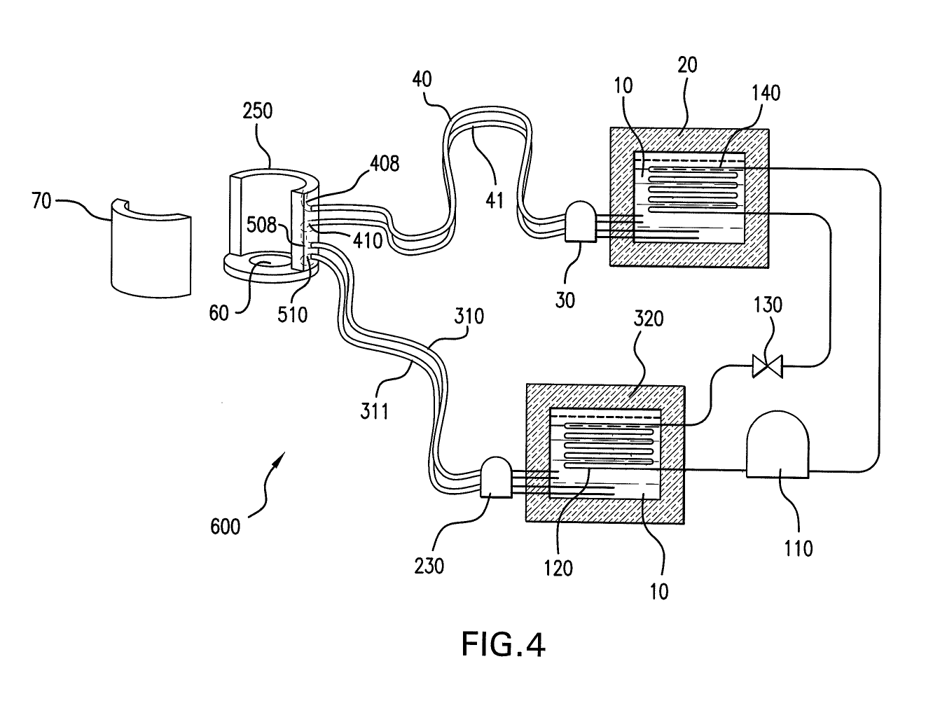

FIG. 4 is a schematic diagram of an exemplary on demand heating and/or cooling dispenser system, according to another aspect.

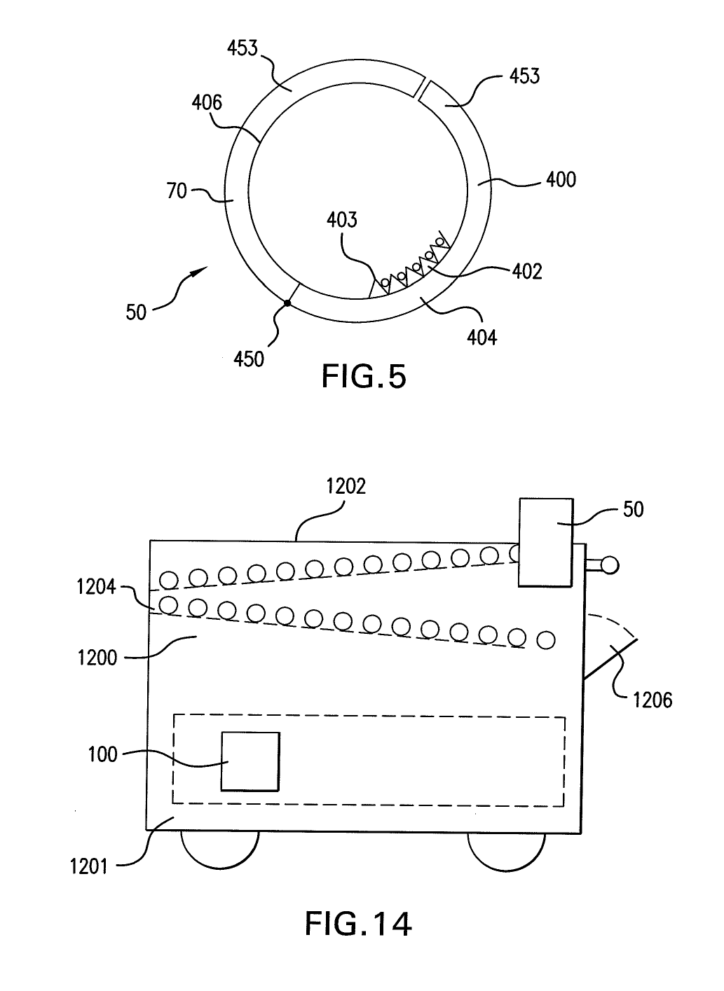

FIG. 5 is an end view of a heat transfer plate of the present application, according to one aspect.

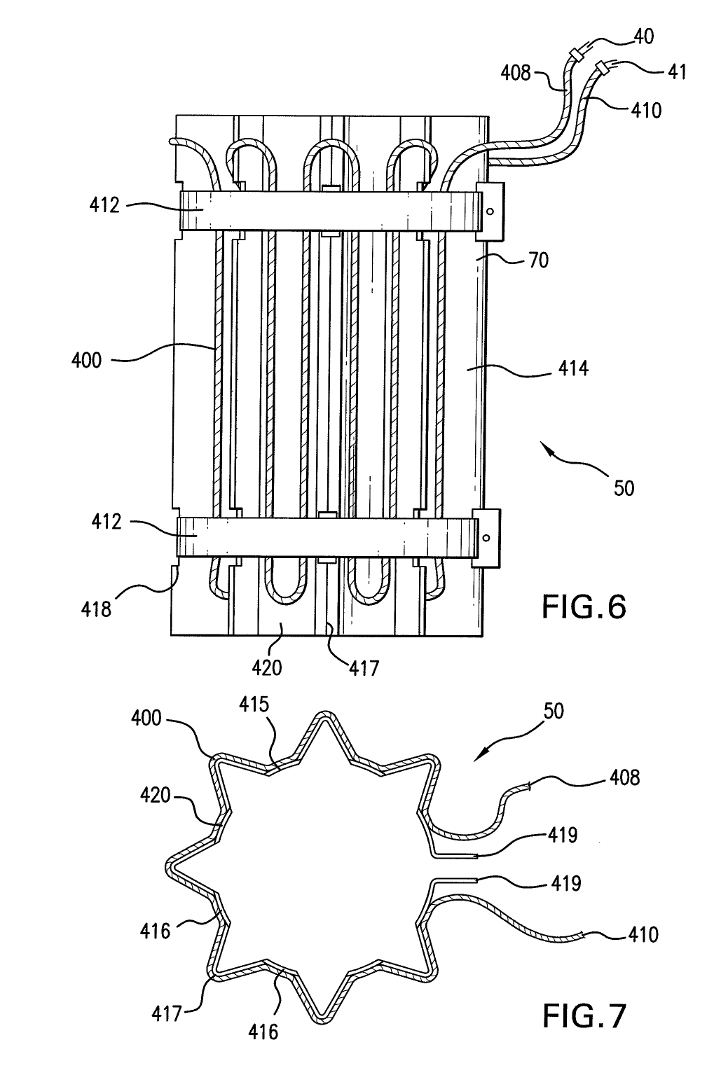

FIG. 6 is a side view of a heat transfer plate of the present application, according to one aspect.

FIG. 7 is an end view of the heat transfer plate of FIG. 6, according to another aspect.

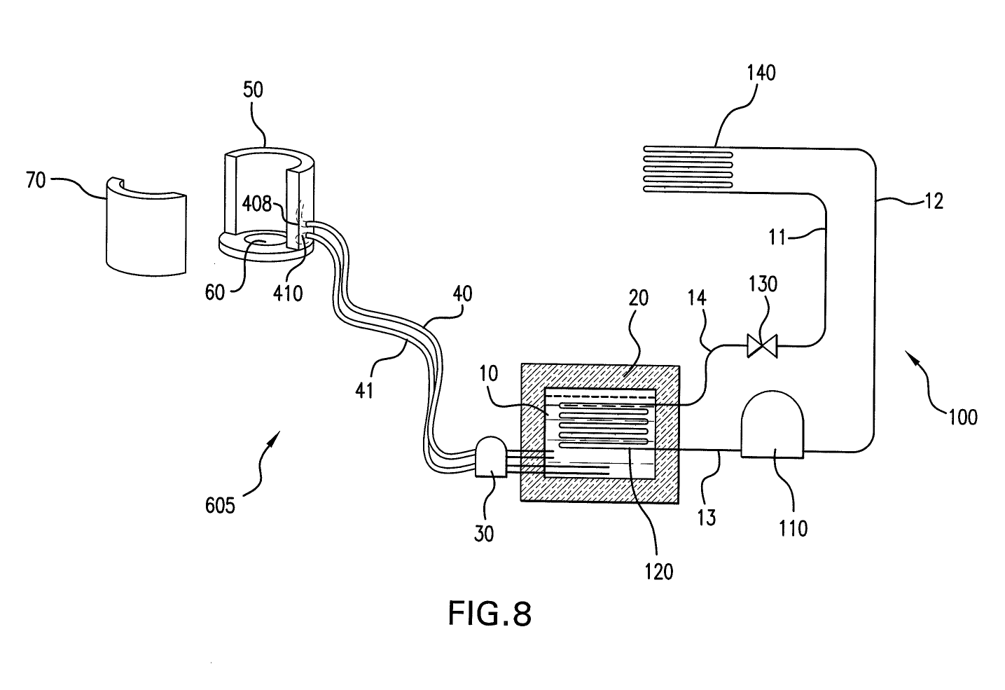

FIG. 8 is a schematic diagram of an exemplary on demand heating and/or cooling dispenser system, according to yet another aspect.

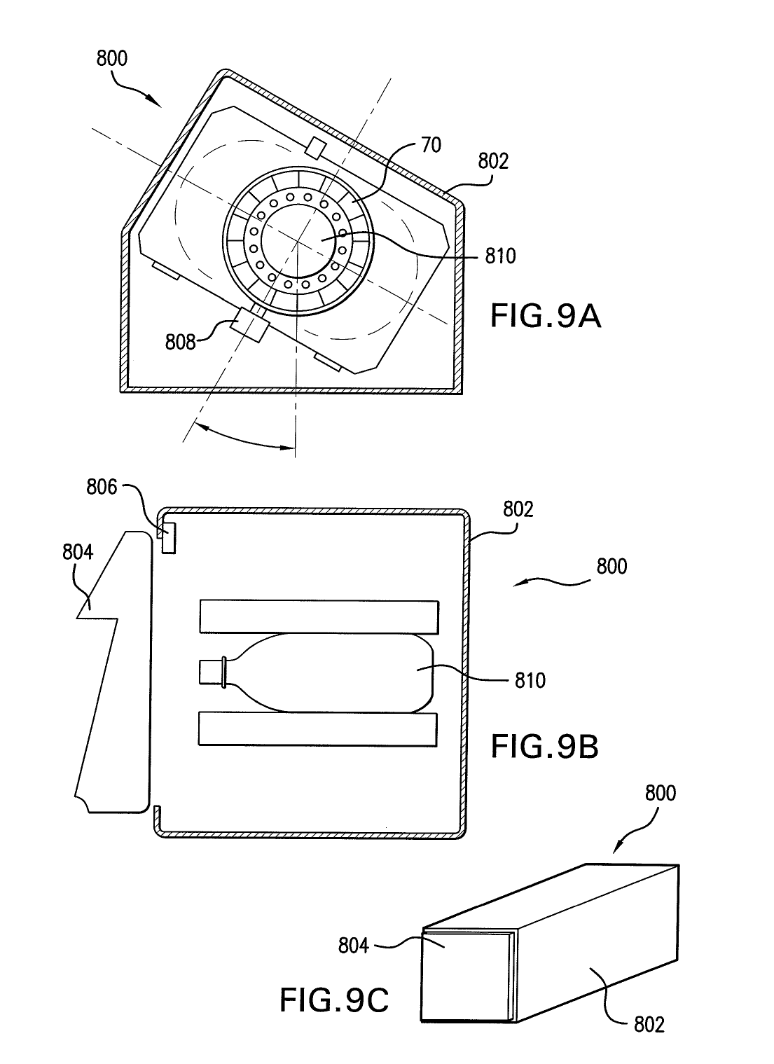

FIG. 9A is an end cross-sectional view of a package mixer of the present application, according to one aspect.

FIG. 9B is a side cross-sectional view of a package mixer of the present application, according to one aspect.

FIG. 9C is a perspective view of the package mixer of the present application, according to one aspect.

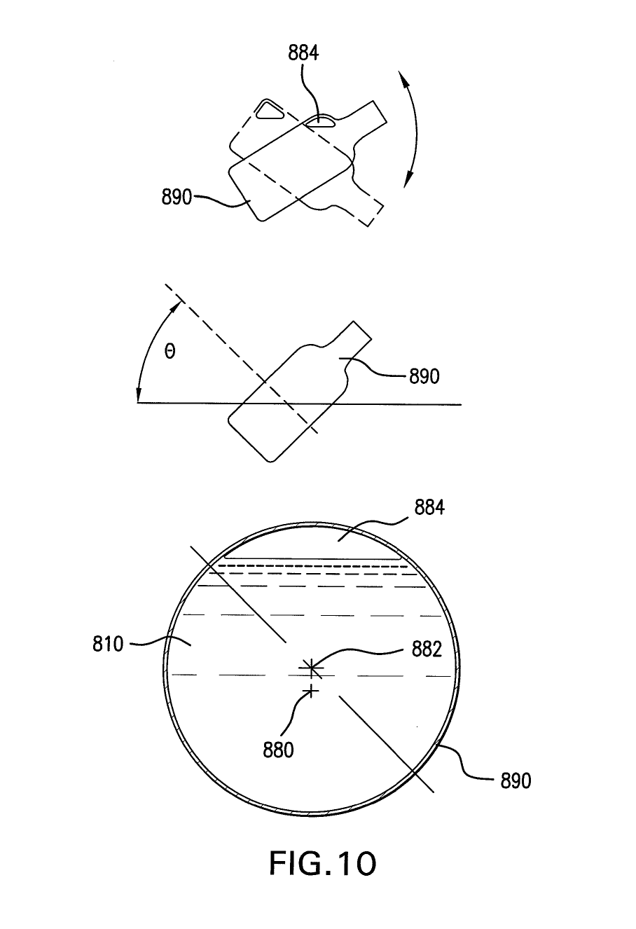

FIG. 10 is a series of cross-sectional views of the contents of a consumable product, according to one aspect.

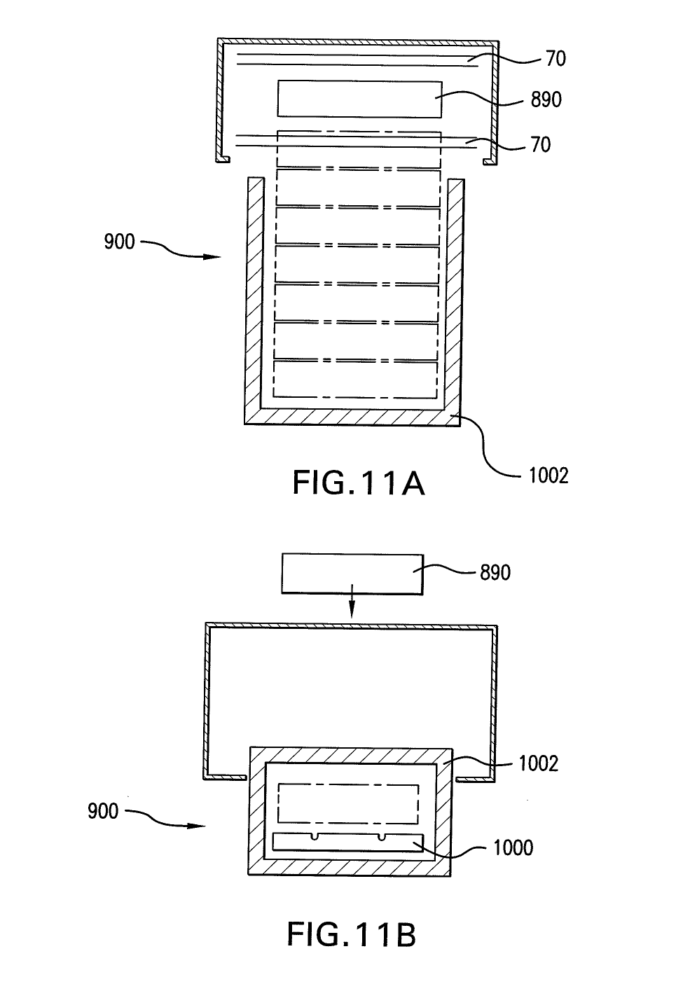

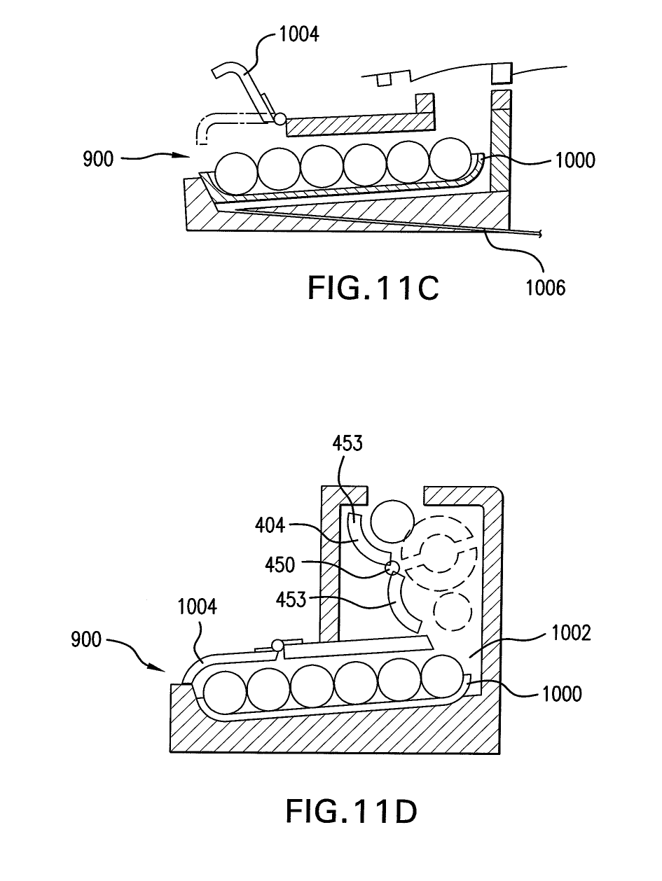

FIG. 11A is a top cross-sectional view of a temperature retention dispenser tray of the present application, according to one aspect.

FIG. 11B is a side cross-sectional view of the temperature retention dispenser tray of FIG. 11A.

FIG. 11C is a side cross-sectional view of the temperature retention dispenser tray of FIG. 11A.

FIG. 11D is a side cross-sectional view of the temperature retention dispenser tray and a package clamp of the present application, according to one aspect.

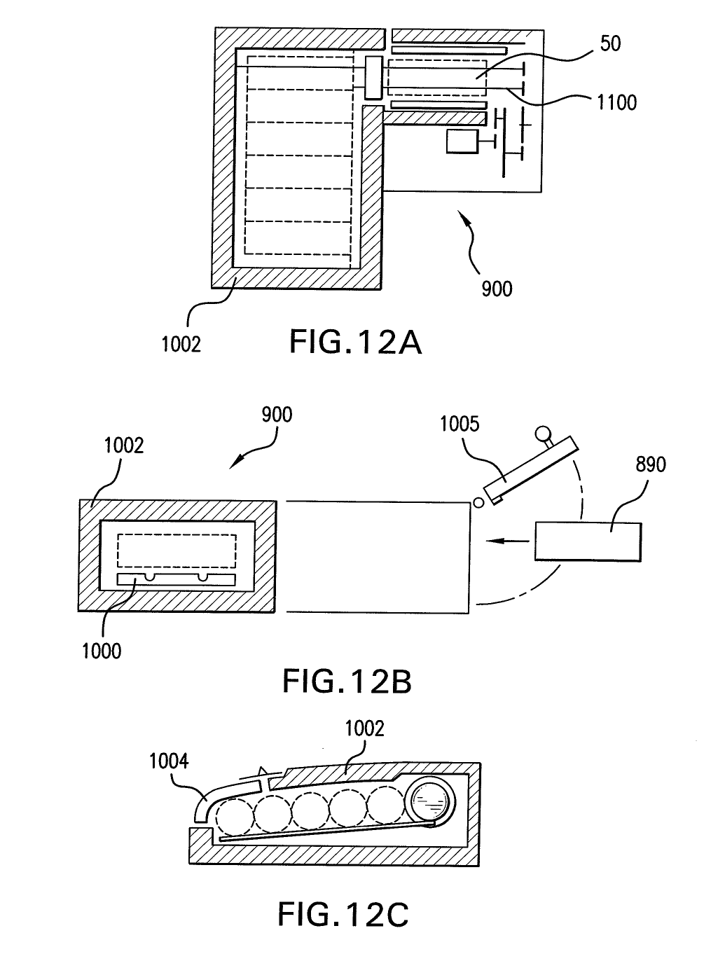

FIG. 12A is a top cross-sectional view of a temperature retention dispenser tray of the present application, according to another aspect.

FIG. 12B is a side cross-sectional view of the temperature retention dispenser tray of FIG. 12A.

FIG. 12C is a side cross-sectional view of the temperature retention dispenser tray of FIG. 12A.

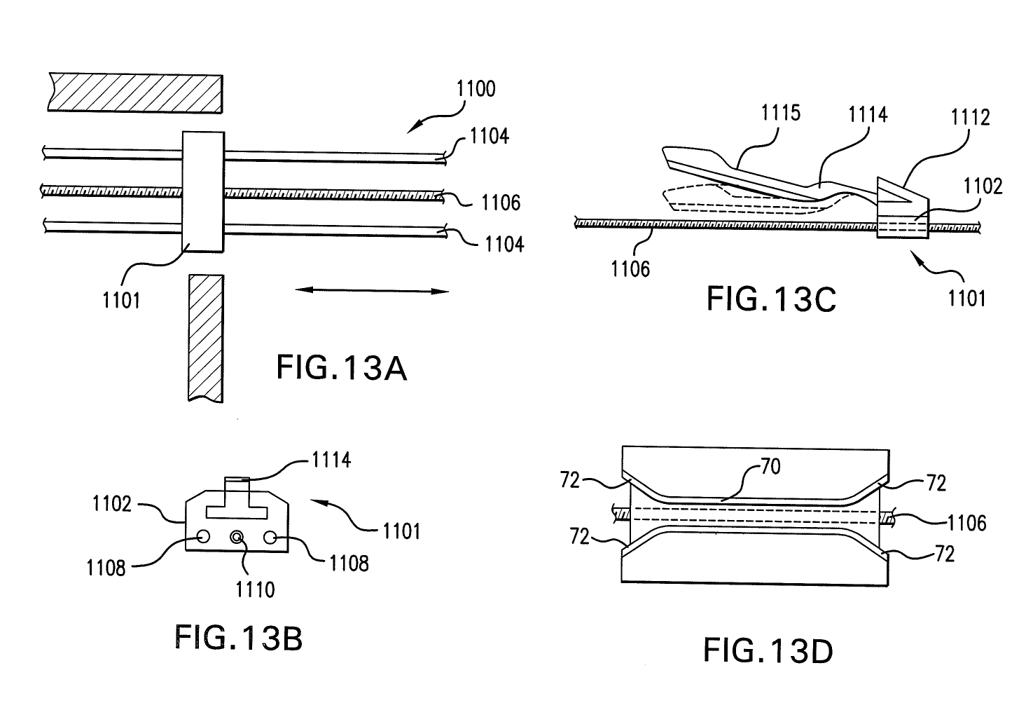

FIG. 13A is a top view of a puck assembly of the present application, according to one aspect.

FIG. 13B is an end view of a puck assembly of the FIG. 13A.

FIG. 13C is a side view of a puck assembly of the FIG. 13A.

FIG. 13D is cross-sectional view of the puck assembly and a package clamp of the present application, according to one aspect.

FIG. 14 is a cross-sectional view of an on demand heating and/or cooling dispenser of the present application showing a mobile platform, according to one aspect.

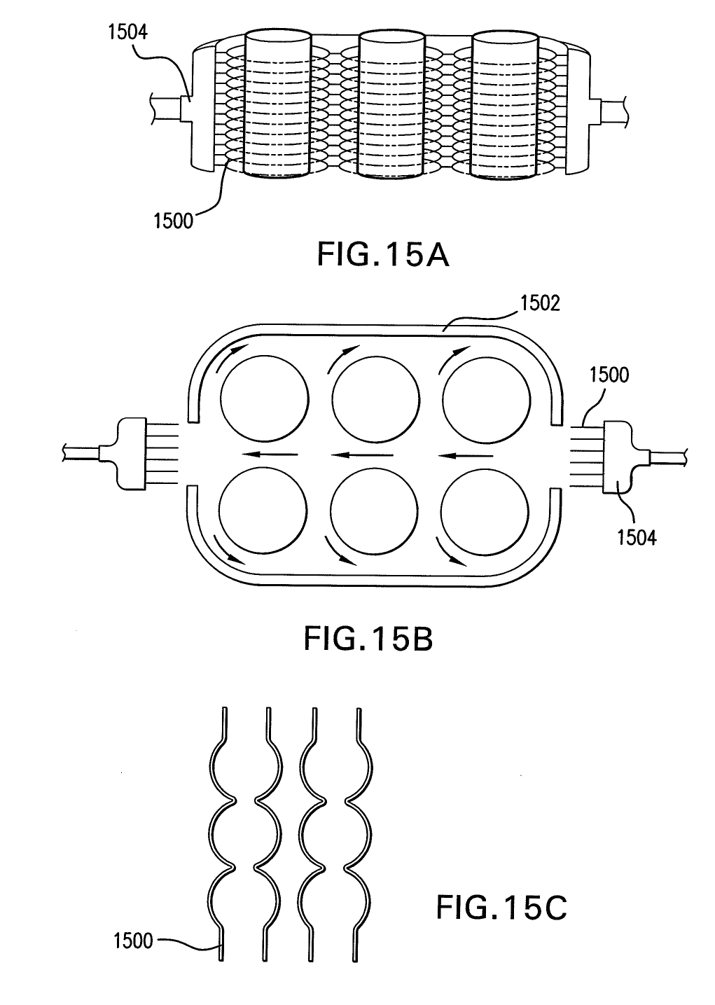

FIG. 15A is a side view of a heat transfer plate of the present application, according to one aspect.

FIG. 15B is a top cross-sectional view of the heat transfer plate FIG. 15A.

FIG. 15C is a top view of a heat transfer plate of the present application, according to another aspect.

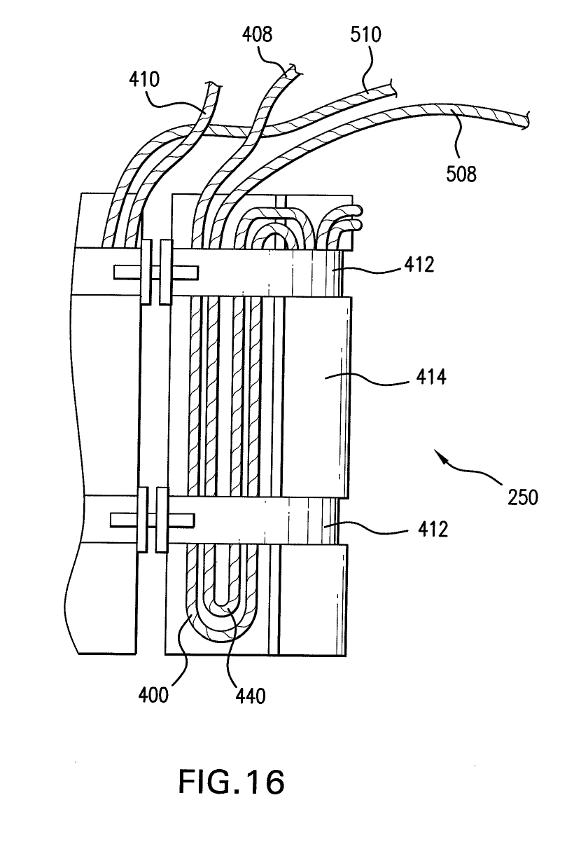

FIG. 16 is a side view of the dual tube heat transfer plate of the present application, according to one aspect.

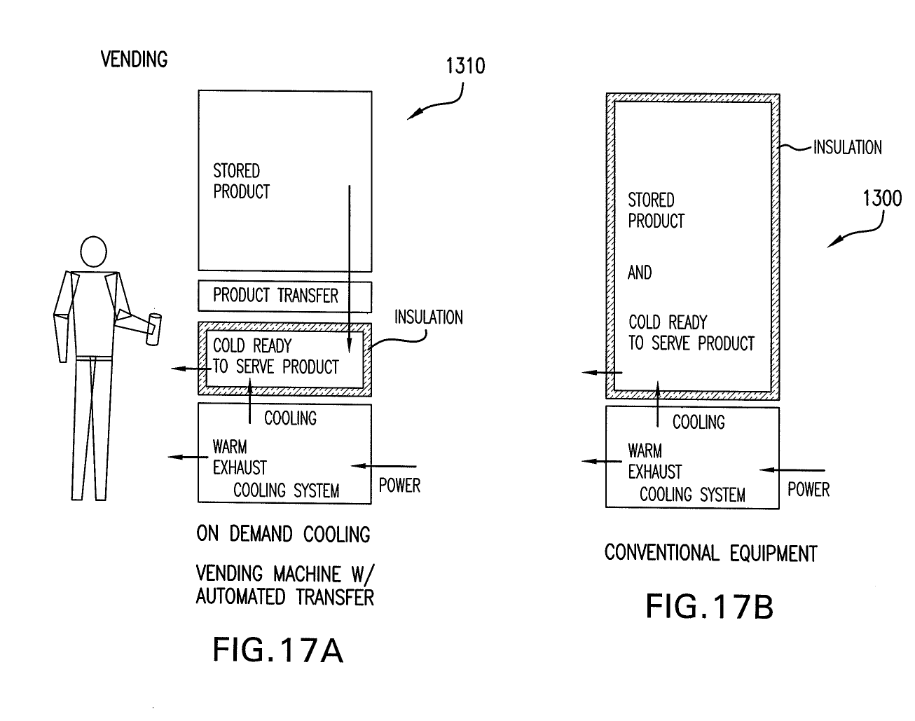

FIGS. 17A and 17B are schematic diagrams of an exemplary on demand heating and/or cooling dispenser system in use in a vending machine, according to one aspect, and a conventional vending machine.

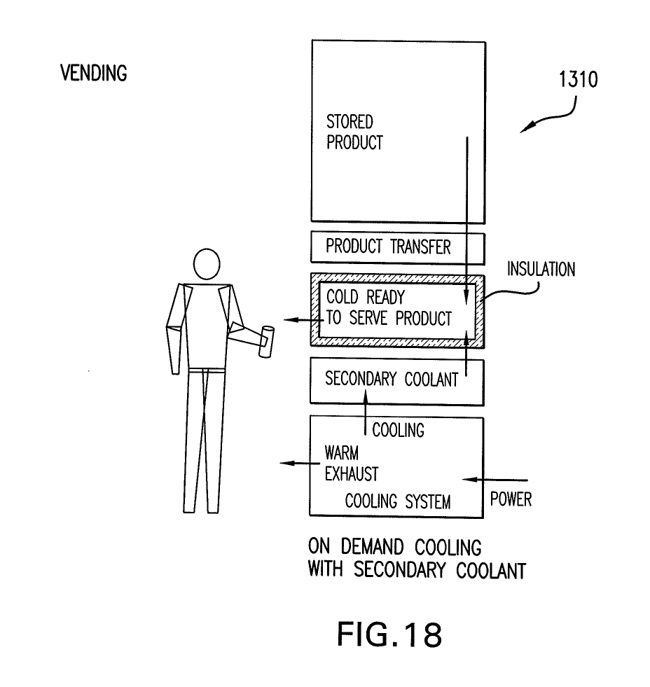

FIG. 18 is a schematic diagram of an exemplary on demand heating and/or cooling dispenser system in use in a vending machine, according to one aspect.

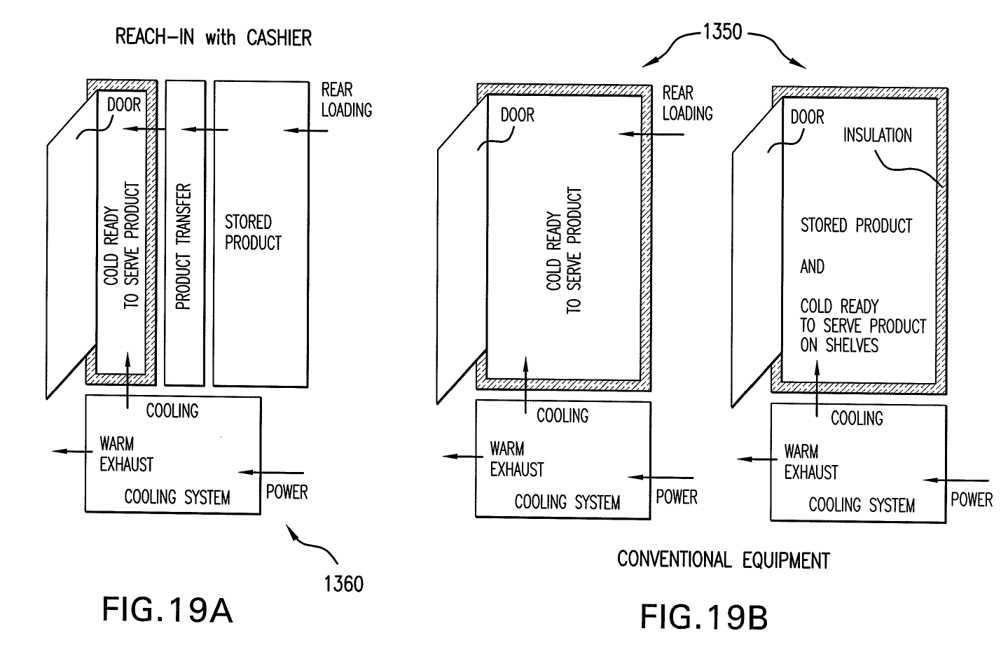

FIGS. 19A and 19B are schematic diagrams of an exemplary on demand heating and/or cooling dispenser system in use in a reach-in dispenser, according to one aspect, and a conventional reach-in dispenser.

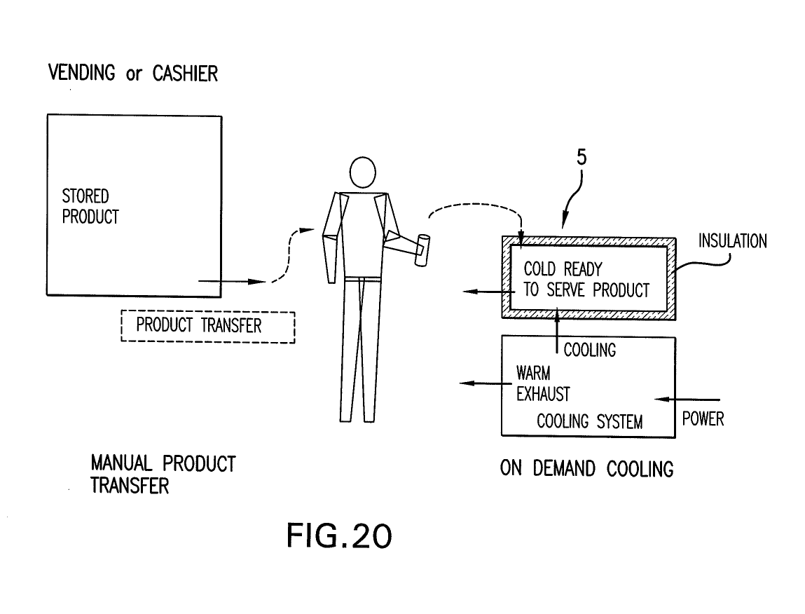

FIG. 20 is a schematic diagram of an exemplary on demand heating and/or cooling dispenser system in use, according to one aspect.

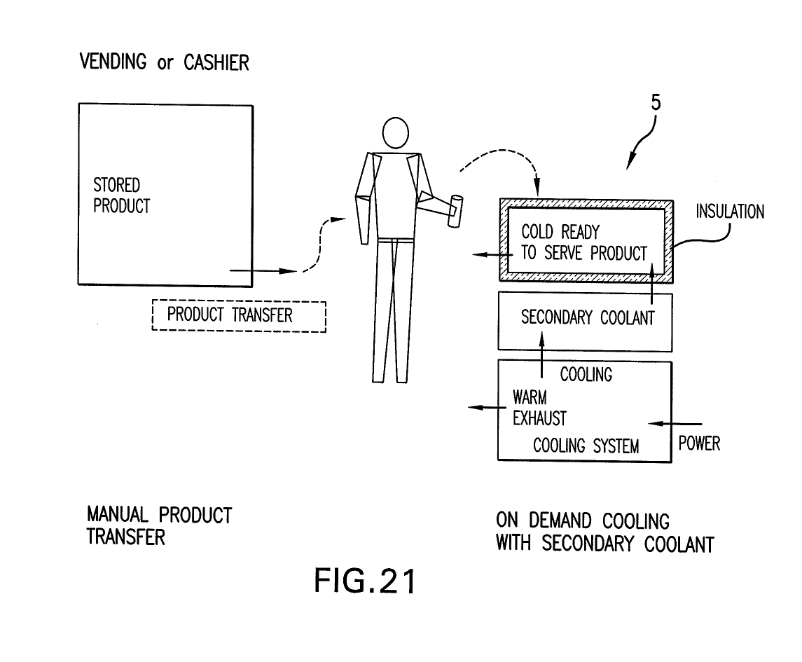

FIG. 21 is a schematic diagram of an exemplary on demand heating and/or cooling dispenser system in use, according to one aspect.

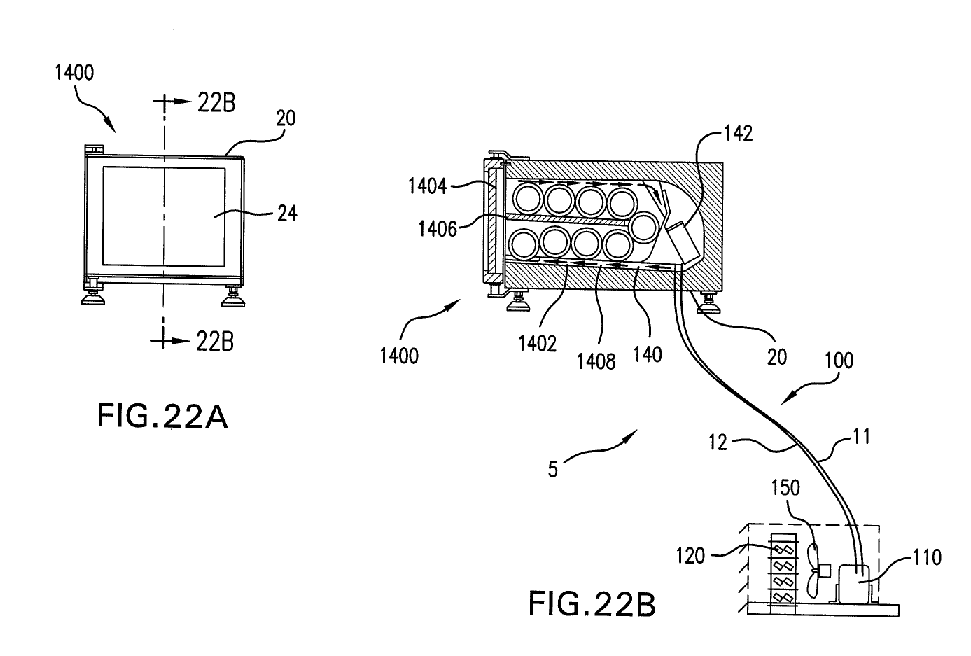

FIG. 22A is a front elevational view of an exemplary on demand heating and/or cooling dispenser system in use in a mini-cooler, according to one aspect.

FIG. 22B is a side cross-sectional view of the on demand heating and/or cooling dispenser system in use in a mini-cooler of FIG. 22A.

### DETAILED DESCRIPTION OF THE INVENTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a package” can include two or more such packages unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

An on demand consumable product heating and/or cooling dispenser is provided, according to various aspects. In one aspect, the on demand consumable product heating and/or cooling dispenser comprises means for conditioning a consumable product within a user accessible device, such as, for example, a vending machine, to a desired temperature on demand. In another aspect, the means for conditioning a consumable product comprises storing energy in a fluid which is used to transfer energy to or from the consumable product. In another aspect, the means for conditioning a consumable product can comprise a conventional heat transfer process such as a vapor compression refrigeration cycle, a vapor absorption refrigeration cycle, inductive heating, thermoelectric cooling, a stirling engine and the like. For clarity, as used herein, the means for conditioning can be a means for heating and/or cooling a consumable product. Also, as used herein, the means for conditioning can be referred to and described with a vapor compression refrigeration cycle, though it is of course understood that any conventional cooling and/or heating process can be used.

For clarity, as used herein, it is contemplated that means for cooling a consumable product can also refer to or is synonymous with means for heating a consumable product, and means for heating a consumable product can also refer to means for cooling a consumable product. As can be appreciated by one of skill in the art, conventional heat transfer processes can be reversed so that a cooling process becomes a heating process and a heating process can become a cooling process. Additionally, as can also be appreciated by one of skill in the art, conventional heat transfer processes can optionally raise or lower the temperature of an item, such as a coolant, by, for example and without limitation, altering the position of the components that comprise the heat transfer process.

In one embodiment, the dispenser can comprise a control system and an on demand cooling system 5. The on demand cooling system can exemplarily comprise a vapor compression refrigeration system 100 and an insulated storage device 20. In other embodiments, and as illustrated in FIG. 1, the on demand cooling system can exemplarily further comprise at least one of: coolant 10, a coolant pump 30, an insulated coolant supply line 40, an insulated coolant return line 41 and a heat transfer plate 50 comprising a package clamp 70 and a plate sensor 60. The vapor compression refrigeration system 100 is illustrated in more detail in FIG. 2, and can exemplarily comprise at least one of: a compressor 110, a condenser 120, a condenser fan 150, an expansion device 130, and an evaporator 140.

In one aspect, the vapor compression refrigeration system 100 circulates a working fluid to move heat from one location to another, as is well known in the art. The components of the refrigeration system are standard components readily available commercially, and are not discussed in detail herein. The coolant pump 30 can, for example, be a conventional pump capable of pumping chilled coolant 10 through insulated coolant supply line 40 and return line 41. Coolant pump 30, coolant 10, insulated coolant supply line 40 and insulated coolant return line 41 are also well known in the art and are standard components that are commercially available.

The insulated storage device 20, in one aspect, can be an insulated container defining an interior volume. In another aspect, the insulated storage device can be formed from metallic or polymeric components. In still another aspect, the insulated storage device can be an insulated liquid storage tank that is sized and configured for receiving the evaporator therein and can form a liquid-tight reservoir for circulating coolant 10 therein. Optionally, in another aspect, the insulated storage device can be sized and configured to receive at least one consumable product therein. For example and without limitation, the insulated storage device can be sized to receive at least one consumable product therein, which can be conditioned by the means for conditioning.

The package clamp 70 of the heat transfer plate can selectively maintain pressure on a heat exchanger tube and/or a consumable product and can comprise a bellows, an inflatable and/or flexible bladder, or other clamping device, as will be described more fully below.

The plate sensor 60 can comprise, in one aspect, a sensor configured to acknowledge the presence of a consumable product in the heat transfer plate 50 and send a signal to the control system. In another aspect, the plate sensor can comprise a switch, as commonly known in the arts, that is configured to send a signal to the control system when a consumable product is located therein the heat transfer plate.

FIG. 5 illustrates one embodiment of the heat transfer plate 50 comprising a heat exchanger tube 400 and a package clamp 70 comprising a bellows 402, and a shell 404. In one aspect, the shell can be substantially cylindrical in shape having an inner surface 406. In another aspect, the shell can be formed of a rigid material sized to hold the bellows and the heat exchanger tube in a position so that a consumable product, such as a can or bottle, can be inserted therein. In yet another aspect, the shell 404 can be formed from a metallic material, such as, for example and without limitation, stainless steel. In another aspect, the shell can be formed from a polymeric material, such as, for example and without limitation, nylon or polypropylene. In still another aspect, the shell can be comprised of at least two shell pieces 453 wherein the shell pieces are rotatably attached to each other by at least one hinge 450. In this aspect, illustrated in FIG. 11D, the shell pieces can have a free end, so that the shell 404 can be rotatably separated around the hinge in clam shell-like manner, thereby allowing consumable products to more easily be placed inside and/or removed from the shell.

The bellows 402, in one exemplary aspect, can be an inflatable compression bladder made from a flexible material that is configured to selectively apply pressure on surfaces undergoing heat exchange to improve thermal conduction. In another aspect, the end view of the bellows can be substantially cylindrical in shape. In yet another aspect, the bellows 402 can be sized to fit inside the inner surface 406 of the shell 404 and can be attached to the inner surface of the shell. In a further aspect, if the shell has hinged pieces, the bellows can have ends configured to align with the unhinged end of the shell so that the bellows can be opened along with the shell 404. In still another aspect, in an uncompressed state, the bellows 402 can have an inner surface 403 sized and configured such that a consumable product, for example a can or bottle, can be inserted therein.

In one aspect, the heat exchanger tube 400 can be a standard heat exchanger tube as is known in the art. In another aspect, the heat exchanger tube can be a rigid tube. In yet another aspect, the heat exchanger tube 400 can be a flexible tube which may conform to the shape of a consumable product. In a further aspect, the heat exchanger tube 400 can be metallic, formed from, for example and without limitation, copper, stainless steel, and the like. In still another aspect, the heat exchanger tube can be formed from polymeric materials, such as for example and without limitation, polypropylene. The heat exchanger tube 400 can be attached to the inner surface 406 of the shell 404 and/or the inner surface 403 of the bellows 402. The heat exchanger tube, in one aspect can be arranged in a serpentine manner around the inner surface of the shell and/or the inner surface of the bellows. When the dispenser is assembled, an inlet end 408 and an outlet end 410 of the heat exchanger tube can be in fluid communication with the insulated coolant supply line 40 and insulated coolant return line 41 so that coolant 10 from the insulated storage device 20 can be circulated throughout the heat exchanger tube. In a further aspect, if the shell 404 has hinged pieces, the heat exchanger tube 400 can have ends that are configured to align with the unhinged end of the shell so that the bellows can be opened along with the shell.

In this embodiment, the heat transfer plate 50 can be assembled by attaching the bellows 402 to the shell 404 using conventional methods such as, for example and without limitation, adhesives, hook and loop fasteners, and the like. The heat exchanger tube 400 can be arranged in a serpentine manner and attached to the shell and/or the bellows using conventional methods such as for, example and without limitation, adhesives, hook and loop fasteners, and the like. The inlet end 408 and the outlet end 410 of the heat exchanger tube can be left accessible for later connection to the insulated coolant supply line 40 and insulated coolant return line 41.

In another embodiment, as illustrated in FIGS. 6 and 7, the heat transfer plate 50 can comprise a heat exchanger tube 400 and a package clamp 70 comprising at least one compression strap 412, and a frame 414. In one aspect, the frame can be formed from a rigid conductive sheet, such as for example and without limitation, a stainless steel sheet, a copper sheet and the like. In this embodiment, the frame can have a discontinuous contacting surface 415 comprising a plurality of contacting surface segments 416.

In one aspect, a plurality of protrusions 417 can be positioned therebetween and extend outwardly therefrom adjacent contacting surface segments. Each protrusion can have at least one notch 418 formed therein the protrusion configured for receiving the at least one compression strap 412, as described more fully below. The at least one notch can be sized so that a compression strap located therein can be tightened, thereby causing at least a portion of the compression step to contact at least a portion of the heat exchanger tube 400 located thereon the exterior of the frame 414. In one aspect, the discontinuous contacting surface 415 can be substantially cylindrical in cross-sectional shape and can be sized to receive therein a consumable product. In another aspect, the frame 414 can further comprise a plurality of tensions flanges 419 separated by a distance and a means for urging the tension flanges towards each other. The tensions flanges can be positioned therebetween and extend outwardly therefrom adjacent contacting surface segments 416, such that when the tension flanges are urged towards each other, the diameter of the discontinuous contacting surface can be decreased. In one aspect, the means for urging the tension flanges towards each other can be a conventional displacement means, such as, for example and not meant to be limiting, electric motors or hydraulic pumps, gears, cams, screws and the like, as are well known in the arts.

In another aspect, the at least one compression strap 412 can be a standard strap having a means for being tightened as is known in the arts. In another aspect, the heat exchanger tube 400 can be as described above.

In this embodiment, the heat transfer plate 50 can be assembled by wrapping the heat exchanger tube 400 around the frame 414 in a serpentine manner, as illustrated in FIG. 6, with at least a portion of the heat exchanger tube being in contact with the valleys 420 formed between the plurality of protrusions 417 of the frame. The heat exchanger tube can be held in place with, for example and without limitation, adhesives, hook and loop fasteners, the at least one compression strap 412, and the like. The inlet end 408 and the outlet end 410 of the heat exchanger tube can be left accessible for later connection to the insulated coolant supply line 40 and the insulated coolant return line 41.

With reference to FIG. 1, the on demand cooling system 5 can be assembled to comprise any or all of the components as described above. For example, in one aspect, the evaporator 140 can be installed therein the insulated storage device 20. A supply line 11 can be connected from the evaporator through the insulated storage device to the expansion device 130 located outside of the insulated storage device. A return line 12 can be connected from the evaporator through the insulated storage device to the compressor 110 located outside of the insulated storage device 20. A second supply line 13 can be connected from the compressor to the condenser 120, and a second return line 14 can be connected from the condenser to the expansion device 130. The condenser fan 150 can be positioned to circulate air over the condenser 120.

In another aspect, the insulated coolant supply line 40 can be attached to the insulated storage device 20, the coolant pump 30, and the inlet end 408 of the heat exchanger tube 400 of the heat transfer plate 50 such that these components are in fluid communication with each other. The insulated coolant return line 41 can be attached to the outlet end 410 of the heat exchanger tube of the heat transfer plate and the insulated storage device so that the outlet end of the heat exchanger tube and the insulated storage device 20 are in fluid communication.

In operation, the insulated storage device 20 can have coolant 10 placed therein. The vapor compression refrigeration system 100 can circulate a working fluid to move heat from the evaporator 140 to the condenser 120, thereby lowering the temperature at the location of the evaporator, as is commonly known in the arts. In this embodiment, because the evaporator is located within the insulated storage device, the vapor compression refrigeration system lowers the temperature of the coolant inside the insulated storage device. In one aspect, it is contemplated that the coolant 10 can be chilled to a temperature of between about −80 degrees Celsius to about 0 degrees Celsius. In another aspect, it is contemplated that the coolant can be chilled to a temperature of approximately −50 degrees Celsius. In still another aspect, it is contemplated that the coolant 10 can be chilled to a temperature of approximately −40 degrees Celsius. In a further aspect, it is contemplated that the coolant can be chilled to a temperature of approximately −30 degrees Celsius.

A consumable product contained in a package can be placed in the heat transfer plate 50. The sensor 60 can recognize the presence of the package and send a signal to the control system. The control system can signal the package clamp 70 to secure the package in the heat transfer plate. In one aspect, if the heat transfer plate comprises a bellows 402, the bellows can be inflated, thereby securing the package and placing the heat exchanger tube 400 in contact with the package. In another aspect, if the heat transfer plate comprises a frame 414, the tension flanges 419 of the frame can be urged towards each other, thereby reducing the diameter of the discontinuous contacting surface 415 of the frame. The diameter of the discontinuous contacting surface can be reduced until the frame is in contact with the package, thereby securing the package.

Upon securing the consumable product therein the heat transfer plate, the control system can signal the coolant pump 30 to circulate coolant 10 through the insulated coolant supply line 40. In one aspect, the coolant pump can draw chilled coolant from the insulated storage device 20. The chilled coolant can flow through the insulated coolant supply line to the inlet end 408 of the heat exchanger tube 400. The chilled coolant can then flow through the heat exchanger tube 400, whereby heat is transferred from the consumable product to the coolant. This lowers the temperature of the product while raising the temperature of the coolant. Upon exiting the outlet end 410 of the heat exchanger tube, the warmed coolant can return through the insulated coolant return line 41 to the insulated storage device 20, where the coolant can be chilled again.

The control system can signal the heat transfer plate 50 when a chill cycle is complete, so that the package clamp 70 can release the consumable product to a user, as will be described more fully below. In one aspect, optionally, the chill cycle can continue until a desired temperature is measured by the sensor 60 of the heat transfer plate. This desired temperature can be programmed into the control system, or in another aspect, can be set by the user. In yet another aspect, optionally, the chill cycle can continue for a desired length of time. This desired length of time can be programmed into the control system, or in one aspect, can be set by the user.

In another embodiment, the on demand consumable product heating and/or cooling dispenser can comprise a control system and an on demand heating system 605. The on demand heating system can comprise a vapor compression refrigeration system 100 and an insulated storage device 20. In other embodiments, and as exemplarily illustrated in FIG. 8, the on demand heating system can exemplarily further comprise at least one of: coolant 10, a coolant pump 30, an insulated coolant supply line 40, an insulated coolant return line 41 and a heat transfer plate 50 comprising a package clamp 70 and a plate sensor 60. The vapor compression refrigeration system 100 is illustrated in more detail in FIG. 2, and can comprise a compressor 110, a condenser 120, a condenser fan 150, an expansion device 130, and an evaporator 140.

In the embodiment illustrated in FIG. 8, in one aspect, the components of the on demand heating system can be the same as the respective corresponding components of the on demand cooling system 5, as described above. In this embodiment, however, the condenser 120, instead of the evaporator 140, can be placed therein the insulated storage device 20. The vapor compression refrigeration system 100 can circulate a working fluid to move heat from the evaporator 140 to the condenser 120, thereby raising the temperature at the location of the condenser, as is commonly known in the arts. In this embodiment, the system can work as described above. However, because the condenser 120 is located within the insulated storage device 20, the vapor compression refrigeration system can raise the temperature of the coolant inside the insulated storage device. In one aspect, it is contemplated that the coolant 10 can be heated to a temperature between about 20 degrees Celsius to about 110 degrees Celsius. In another aspect, it is contemplated that the coolant can be heated to a temperature of approximately 90 degrees Celsius. In still another aspect, it is contemplated that the coolant 10 can be heated to a temperature of approximately 80 degrees Celsius. In another aspect, it is contemplated that the coolant can be heated to a temperature of approximately 70 degrees Celsius.

With reference to FIG. 8, the on demand heating system 605 can be assembled to comprise any or all of the components as described above. The components of the on demand heating system can be assembled as previously descried, except however the condenser 120 of the vapor compression refrigeration system can be located therein the insulated storage device. In one aspect, the insulated coolant supply line 40 can be attached to the insulated storage device 20, the coolant pump 30, and the inlet end 408 of the heat exchanger tube 400 of the heat transfer plate 50 so that these components can be in fluid communication with each other. The insulated coolant return line 41 can be attached to the outlet end 410 of the heat exchanger tube of the heat transfer plate and the insulated storage device so that the outlet end of the heat exchanger tube 400 and the insulated storage device 20 are in fluid communication. Coolant 10 can be added to the insulated storage device.

In operation, the vapor compression refrigeration system 100 of the on demand heating system 605 can circulate a working fluid to move heat from the evaporator 140 to the condenser 120, thereby lowering the temperature at the location of the evaporator and raising the temperature at the location of the condenser, as are commonly known in the arts. In this embodiment, because the condenser is located within the insulated storage device 20, the vapor compression refrigeration system raises the temperature of the coolant 10 inside the insulated storage device.

A consumable product contained in a package, such as a can or a bottle, can be placed in the heat transfer plate 50. The sensor 60 can recognize the presence of the package and send a signal to the control system. The control system can then signal the package clamp 70 to secure the package in the heat transfer plate, as previously described. Upon securing the consumable product therein the heat transfer plate, the control system can signal the coolant pump 30 to circulate coolant 10 through the insulated coolant supply line 40, thereby raising the temperature of the consumable product and lowering the temperature of the coolant. Upon exiting the outlet end 410 of the heat exchanger tube, the chilled coolant can return through insulated coolant return line 41 to the insulated storage device 20, where the coolant can be heated again.

The control system can signal the heat transfer plate 50 when a package heating cycle is complete, so that the package clamp 70 can release the consumable product to a user, as will be described more fully below. In one aspect, optionally, the heating cycle can continue until a desired temperature is measured by the sensor 60 of the heat transfer plate. This desired temperature can be programmed into the control system, or in another aspect, can be set by the user. In yet another aspect, optionally, the heating cycle can continue for a desired length of time. This desired length of time can be programmed into the control system, or in one aspect, can be set by the user.

In another embodiment, the on demand consumable product heating and/or cooling dispenser can comprise a control system an on demand cooling and heating system. The on demand cooling and heating system 500, illustrated in FIG. 3, can comprise the components of the on demand cooling system 5 as described above and can further comprise at least one of: a second insulated storage device 320, a second coolant pump 230, a second insulated coolant supply line 310, a second insulated coolant return line 311, and a second heat transfer plate 280 comprising a second package clamp 270 and a second plate sensor 260. In this exemplary aspect, the second insulated storage device, the second coolant pump, the second set of insulated coolant lines, the second heat transfer plate, the second plate sensor, and the second package clamp can be substantially the same as their respective counterparts described above in reference to the on demand cooling system. Thus, the second insulated storage device 320 can be substantially the same as insulated storage device 20; second coolant pump 230 can be substantially the same as coolant pump 30; the second set of insulated coolant lines 310, 311 can be substantially the same as insulated coolant lines 40, 41; the second heat transfer plate 280 can be substantially the same as heat transfer plate 50; the second plate sensor 260 can be substantially the same as plate sensor 60; and the second package clamp 270 can be substantially the same as package clamp 70.

With reference to FIG. 3, the on demand cooling and heating system 500 can be assembled to comprise any or all of the components as described above. The components of the on demand cooling system 5 can be assembled as previously described. In one aspect, however, the condenser 120 can be located therein the second insulated storage device 320. Thus, when the vapor compression refrigeration system 100 is in operation, as described above, the temperature within the second insulated storage device will rise. In another aspect, the second insulated coolant supply line 310 can be attached to the second insulated storage device 320, the second coolant pump 230, and the inlet end 408 of the heat exchanger tube 400 of the second heat transfer plate 280 so that these components can be in fluid communication with each other. The second insulated coolant return line 311 can be attached to the outlet end 410 of the heat exchanger tube of the second heat transfer plate and the second insulated storage device so that the outlet end of the heat exchanger tube and the second insulated storage device 320 can be in fluid communication with each other. Coolant 10 can be added to the second insulated storage device. In one aspect, the coolant added to the second insulated storage device 320 can be the same type of fluid as the coolant of the insulated storage device 20. In another aspect, the coolant added to the second insulated storage device can be a different type of fluid as the coolant of the insulated storage device.

In operation, the vapor compression refrigeration system 100 can circulate a working fluid to move heat from the evaporator 140 to the condenser 120, thereby lowering the temperature at the location of the evaporator and raising the temperature at the location of the condenser, as are commonly known in the arts. In this embodiment, because the evaporator is located within the insulated storage device, the vapor compression refrigeration system lowers the temperature of the coolant inside the insulated storage device 20. Additionally, because the condenser is located within the second insulated storage device 320, the vapor compression refrigeration system raises the temperature of the coolant 10 inside the second insulated storage device. In one aspect, the temperature of the coolant 10 at the evaporator 140 can be chilled as described above, and the temperature of the coolant at the condenser can be heated as described above.

A consumable product contained in a package can be placed in the heat transfer plate 50 or the second heat transfer plate 280. If a consumable product is located therein the heat transfer plate 50, the sensor 60 can recognize the presence of the package and send a signal to the control system. The control system can signal the package clamp 70 to secure the package in the heat transfer plate, as previously described. Upon securing the consumable product therein the heat transfer plate, the control system can signal the coolant pump 30 to circulate coolant 10 through the insulated coolant supply line 40, thereby lowering the temperature of the consumable product, also as previously described. Upon completion of the package cooling cycle, the control system can signal the coolant pump 30 to stop and the package clamp 70 to release the consumable product to a user, as will be described more fully below. In one aspect, the cooling cycle can continue until a desired temperature is measured by the sensor 60 of the heat transfer plate 50. This desired temperature can be programmed into the control system, or in another aspect, can be set by the user. In yet another aspect, the cooling cycle can continue for a desired length of time. This desired length of time can be programmed into the control system, or in one aspect, can be set by the user. In another aspect, the control system can be configured to end the cooling cycle (e.g., stop the coolant pump) when a predetermined temperature is reached in order to prevent damage to the equipment and/or frosting which could temporarily prevent the device from operating.

If a consumable product is located therein the second heat transfer plate 280, the second plate sensor 260 can recognize the presence of the package and send a signal to the control system. The control system can signal the second package clamp to secure the package in the second heat transfer plate. The second package clamp 270 can operate to secure the package in the same manner as described with reference to package clamp 70. Upon securing the consumable product therein the second heat transfer plate 280, the control system can signal the second coolant pump 230 to circulate coolant 10 through the second insulated coolant supply line 310. In one aspect, the second coolant pump can draw heated coolant from the second insulated storage device 320. The heated coolant can flow through the second insulated coolant supply line 310 to the inlet end 408 of the heat exchanger tube. The heated coolant can then flow through the heat exchanger tube 400, whereby heat is transferred from the coolant to the consumable product. This raises the temperature of the consumable product while lowering the temperature of the coolant. Upon exiting the outlet end 410 of the heat exchanger tube, the cooled coolant 10 can return through the second insulated return line 311 to the second insulated storage device 320, where the coolant can be heated again.

After the package heating cycle is complete, the control system can signal the second coolant pump 230 to stop and the second package clamp 270 to release the consumable product to a user, as will be described more fully below. In one aspect, the heating cycle can continue until a desired temperature is measured by the second sensor 260 of the second heat transfer plate 280. This desired temperature can be programmed into the control system, or in another aspect, can be set by the user. In yet another aspect, the heating cycle can continue for a desired length of time. This desired length of time can be programmed into the control system, or in one aspect, can be set by the user.

In another embodiment, the on demand consumable product heating and/or cooling dispenser can comprise a control system and a single cold plate on demand cooling and heating system. As illustrated in FIG. 4, the single cold plate on demand cooling and heating system 600 can exemplarily comprise at least one of: a vapor compression refrigeration system 100, an insulated storage device 20, a second insulated storage device 320, a coolant pump 30, a second coolant pump 230, an insulated coolant supply line 40, an insulated coolant return line 41, a second insulated coolant supply line 310, a second insulated coolant return line 311, a dual tube heat transfer plate 250, a sensor 60, and a package clamp 70. In one aspect, the dual tube heat transfer plate 250 can be formed essentially as described above, with the addition of a second heat exchanger tube 440 that can be arranged in a serpentine fashion adjacent or near the first heat exchanger tube 400, as illustrated in FIG. 16. In this embodiment, the other components of the single cold plate on demand cooling and heating system 600 can be substantially the same as their respective counterparts described above with reference to the on demand cooling and heating system 500.

With reference to FIG. 4, the single cold plate on demand cooling and heating system 600 can be assembled to comprise any or all of the components as described above. In one aspect, the evaporator 140 of the vapor compression refrigeration system 100 can be located therein the insulated storage device 20. In another aspect, the condenser 120 of the vapor compression refrigeration system can be located therein the second insulated storage device 320. The insulated coolant supply line 40 can be attached to the insulated storage device 20, the coolant pump 30, and the inlet end 408 of the heat exchanger tube 400 of the dual tube heat transfer plate 250 so that these components can be in fluid communication with each other. The insulated coolant return line 41 can be attached to the outlet end 410 of the heat exchanger tube of the dual tube heat transfer plate and the insulated storage device so that the outlet end of the heat exchanger tube 400 and the insulated storage device 20 can be in fluid communication. The second insulated coolant supply line 310 can be attached to the second insulated storage device 320, the second coolant pump 230, and the inlet end 508 of the second heat exchanger tube 440 of the dual tube heat transfer plate 250 so that these components can be in fluid communication with each other. The second insulated coolant return line 311 can be attached to the outlet end 510 of the second heat exchanger tube of the dual tube heat transfer plate and the second insulated storage device so that the outlet end of the second heat exchanger tube 440 and the second insulated storage device 320 can be in fluid communication. Coolant 10 can be placed therein the insulated storage device 20 and the second insulated storage device. In one aspect, the coolant added to the second insulated storage device 320 can be the same type of fluid as the coolant of the insulated storage device 20. In another aspect, the coolant added to the second insulated storage device can be a different type of fluid as the coolant of the insulated storage device.

In operation, the vapor compression refrigeration system 100 can circulate a working fluid to move heat from the evaporator 140 to the condenser 120, thereby lowering the temperature at the location of the evaporator and raising the temperature at the location of the condenser, as are commonly known in the arts. In this embodiment, because the evaporator is located within the insulated storage device 20, the vapor compression refrigeration system lowers the temperature of the coolant inside the insulated storage device. Additionally, because the condenser is located within the second insulated storage device 320, the vapor compression refrigeration system 100 raises the temperature of the coolant 10 inside the second insulated storage device. In one aspect, it is contemplated that the temperature of the coolant at the evaporator and condenser can be as described above.

A consumable product contained in a package can be placed in the dual tube heat transfer plate 250. In one aspect, it is contemplated that a user of the single cold plate on demand cooling and heating system 600 can select whether the consumable product should be heated or chilled. In another aspect, it is contemplated that logic associated with the control system can select whether the consumable product should be heated or chilled based on a feature of the consumable product, such as the size and/or shape of the package. The sensor 60 can recognize the presence of the package and send a signal to the control system. The control system can signal the package clamp 70 to secure the package in the heat transfer plate. In one aspect, if the dual tube heat transfer plate comprises a bellows 402, the bellows can be inflated as described above, thereby placing the heat exchanger tube 400 and the second heat exchanger tube in contact with the package and securing the package. In another aspect, if the dual tube heat transfer plate comprises a frame 414, the tension flanges 419 of the frame can be urged towards each other, thereby reducing the diameter of the discontinuous contacting surface 415 of the frame, thereby placing the frame in contact with the package and securing the package, also as described above.

Upon securing the consumable product therein the dual tube heat transfer plate, the control system can signal the coolant pump 30 or the second coolant pump 230, as appropriate, to circulate coolant 10 through the appropriate insulated coolant supply line 40, 310. In one aspect, if the consumable product is to be chilled, the coolant pump 30 can draw chilled coolant from the insulated storage device 20 and circulate the chilled coolant through insulated coolant supply line 40 to the heat exchanger tube 400. The chilled coolant can then flow through the heat exchanger tube 400, whereby heat is transferred from the consumable product to the coolant, lowering the temperature of the product. The coolant can return through insulated coolant return line 41 to the insulated storage device 20 where it can be chilled again. In another aspect, if the consumable product is to be heated, the second coolant pump 330 can draw heated coolant from the second insulated storage device 320 and circulate the heated coolant through the second insulated coolant supply line 310 to the second heat exchanger tube 440. The heated coolant can then flow through the second heat exchanger tube, whereby heat is transferred from the coolant to the consumable product, raising the temperature of the package. The coolant can return through the second insulated coolant return line 311 to the second insulated storage device 320, where it can be heated again.

In still another embodiment, it is contemplated that the on demand consumable product heating and/or cooling dispenser can comprise a control system and an on demand heating system comprising the components of the on demand cooling system 5, as previously described, and a reversing circuit so that the vapor compression refrigeration system 100 can run in reverse, thereby heating the coolant instead of chilling it.

In yet another embodiment, it is contemplated that the on demand consumable product heating and/or cooling dispenser can comprise a control system, an on demand cooling system 5, as previously described, and a reversing switch and circuit so that the vapor compression refrigeration system 100 can run in reverse. In this embodiment, the vapor compression refrigeration system can be run forwards so that the coolant 10 is chilled, or in reverse so that the coolant is heated. In operation, it is contemplated that a user can set the reversing switch to either heat or chill the coolant. The control system and the reversing circuit can start and run the vapor compression refrigeration system in the appropriate manner to provide the product at the temperature selected by the user.

In another embodiment, it is contemplated that the on demand consumable product heating and/or cooling dispenser can comprise a control system, a vapor compression refrigeration system 100, and a heat transfer plate 50. In this embodiment, the supply lines 11, 13 and/or the return lines 12, 14 of the vapor compression refrigeration system can be placed in fluid communication with the heat exchanger tube 400 of the heat transfer plate so that the working fluid of the vapor compression refrigeration system can chill or heat a consumable product placed therein the heat transfer plate. In this embodiment, it is contemplated that the heat exchanger tube and/or the package clamp 70 of the heat transfer plate can be formed from metallic components because of the relatively high pressure of the working fluid of the vapor compression refrigeration system.

The on demand heating and/or cooling dispenser of the present application can comprise an on demand heating and/or cooling system as described above. In one aspect, the on demand heating and/or cooling dispenser can further comprise a means for agitating a consumable product to enhance heat transfer. In one embodiment, the means for agitating the consumable product can comprise a package mixer 800. In one aspect, as illustrated in FIGS. 9A and 9B, the package mixer can be integrated with the heat transfer plate 50, the second heat transfer plate 280, and/or the dual tube heat transfer plate 250. In another aspect, the package mixer can be separate from any heat transfer plate.

In one aspect, the package mixer 800 can exemplarily comprise at least one of: a mixer housing 802, a safety door 804, a safety switch 806, a package clamp 70, and means 808 for mixing the consumable product 810. The means for mixing the consumable product can provide circulation of the liquid forming the consumable product to enhance heat transfer without causing excessive foaming, release of carbonation, and/or pressure increase of the consumable product.

In one aspect, and as illustrated in FIG. 9C, the mixer housing can be any structure large enough to contain the consumable product, the package clamp and movable components of the means for mixing the product therein. The safety door can be attached to the mixer housing 802 to provide access to the interior of the housing. In another aspect, the safety switch, as known in the arts, can monitor whether the safety door 804 is open or closed. When the safety door is in a closed position, the safety switch 806 can signal the control system of the dispenser, as described above, that the safety door is closed and the means 808 for mixing the consumable product can be activated. When the safety door is in an open position, the safety switch 806 can prevent the means for mixing the consumable product 810 from activating.

In one aspect, the package clamp 70 of the package mixer can maintain pressure on a consumable product thereby preventing the package of the consumable product from moving relative to the package clamp. In another aspect, as described above, the package clamp can comprise, without limitation, a bellows, an inflatable bladder, or other clamping device. In a package mixer 800 integrated with a heat transfer plate 50, a second heat transfer plate 280, and/or a dual tube heat transfer plate 250, in one aspect, the package clamp 70 of the package mixer can be the same package clamp of the appropriate heat transfer plate 50, 280, 250.

In one aspect, the means 808 for mixing the consumable product therein the mixer housing 802 can be conventional rotational and/or conventional displacement means, such as, for example and not meant to be limiting, electric motors or hydraulic pumps, gears, cams and the like, as are well known in the arts. In another aspect, the means for mixing the consumable product may utilize a pattern of motion wherein the consumable product is rotated periodically about an axis. In another aspect, the means for mixing the consumable product may utilize a pattern of motion wherein the consumable product is rotated periodically about an axis that is offset from the center of gravity of the consumable product, as will be described more fully below. In yet another aspect, the means for mixing the consumable product may utilize a pattern of motion wherein the consumable product is moved periodically along an axis.

In use, a consumable product 810 can be inserted therein the package clamp 70 inside the mixer housing 802. The consumable product can be inserted into the package clamp manually or automatically, as will be described more fully below. The package clamp can secure the consumable product, as described previously. The safety door 804 of the mixer housing can be closed, and the safety switch 806 can signal the control system of the dispenser that the means 808 for mixing the consumable product can be activated. The means for mixing the consumable product can cause the product to rotate an offset angle from the direction of gravity. In one aspect, optimum mixing of liquid inside cylindrically shaped packages, such as consumable products like bottle or cans, can be performed by a motion of reversing cycles of rotation about an offset angle Θ of 20-30 degrees with rotation cycles of ± about 30 degrees at a rate of about one cycle per second. In another aspect, an offset angle Θ of 30-90 degrees with rotation cycles off about 50 degrees at a rate of about one cycle per second can provide sufficient circulation of a liquid contained within the package. In yet another aspect, an offset angle Θ of 10-20 degrees with rotation cycles of ± about 20 degrees at a rate of about one cycle per second can provide sufficient circulation of the liquid. In still other aspects, the rate of rotation can be increased to up to ten cycles per second at any of the offset angles Θ described herein.

With reference to FIG. 10, in one aspect, the means 808 for mixing the consumable product 810 contained in a package 890 can move one end of the package below the center of gravity 880 of the package. Because a package has gas 884 (i.e., air) entrapped therein, the center of gravity (mass) of the liquid contained within the package is just below the geometric center 882 of the package. Additionally, because any gas trapped in the package 890 is less dense than a liquid contained therein the package, moving one end of the package below the center of gravity 880 of the package can cause any gas inside of the package 890 to move from one end of the package to the other, helping circulate of the contents of the package. In another aspect, when the package 890 rotates about an offset axis, the liquid of the package can move in a circumferential motion, thereby increasing the circulation of the liquid in that direction.

In another embodiment, the on demand consumable product heating and/or cooling dispenser can further comprise a temperature retention dispenser tray 900, as illustrated in FIGS. 11A, 11B, 11C, and 11D. The temperature retention dispenser tray can, in one aspect, stabilize the temperature of the consumable product until a user requests or desires the product. Additionally, the consumer access door can allow a consumable product to be dispensed without substantially disrupting the temperature of other consumable products located within the on demand consumable product heating and/or cooling dispenser.

In one aspect, the temperature retention dispenser tray can exemplarily comprise at least one of: a temperature retention cold plate 1000, an insulated dispenser chute 1002, a consumer access door 1004, and a safety door 1005. The temperature retention cold plate can be, in one aspect, a standard, commercially available cold plate. Coolant from the insulated storage device 20 can be circulated through the temperature retention cold plate in order to chill the cold plate, as commonly known in the arts. At least one condensation drain line 1006 can be provided at a low point of the insulated dispenser chute 1002 to drain away any condensation that forms. The insulated dispenser chute can be a standard insulated dispenser chute, as also known in the arts. Additionally, in one aspect, the consumer access door 1004 can be a standard consumer access door, also as known in the arts. In another aspect, the consumer access door can comprise an insulating material.

In this embodiment, the consumer access door 1004 can be located at an end of the insulated dispenser chute 1002. The consumer access door can limit a consumer's access to the consumable products located therein the insulated dispenser chute and can further help insulate the insulated dispenser chute. The insulated dispenser chute 1002 can be positioned at an inclined angle, so that consumable products can be gravity fed towards the consumer access door. The temperature retention cold plate 1000 can be located on a surface inside the chute so that consumable products maintain their temperature while awaiting removal by a user.

In one aspect, the temperature retention dispenser tray 900 can be located below a heat transfer plate 50, 250, 280 of the on demand cooling and/or heating system, as illustrated in FIG. 11D. In use, the control system can signal the package clamp 70 of the heat transfer plate to release the consumable product. In one aspect, the heat transfer plate can comprise a hinged shell 404, as previously described, such that when the package clamp is released, the consumable product can be gravity fed directly into the temperature retention dispenser tray.

In another aspect, the temperature retention dispenser tray 900 can be located at the side (i.e., horizontally) of the respective heat transfer plates 50, 250, 280 of the on demand cooling and/or heating system, as illustrated in FIGS. 12A, 12B, and 12 C. In this aspect, the on demand consumable product heating and/or cooling dispenser can further comprise a puck assembly 1100 configured to move consumable products horizontally from a heat transfer plate to the temperature retention dispenser tray. In still another aspect, the puck assembly can be configured to move consumable products horizontally into the heat transfer plate.

FIGS. 13A, 13B, and 13C illustrate one embodiment of the puck assembly. In one aspect, the puck assembly 1100 can exemplarily comprise at least one of: a plurality of smooth rods 1104, at least one threaded rod 1106, and a puck 1101 comprising a puck base 1102, a puck ramp 1112, and a puck spring 1114. An exemplary puck is illustrated in FIG. 13B. In one aspect, the puck base can have a plurality of smooth openings 1108 sized and configured to receive the plurality of smooth rods therein. In another aspect, the puck base 1102 can have at least one threaded opening 1110 sized and configure to receive the at least one threaded rod. In still another aspect, the puck ramp can be a sloped surface on top of the puck base. In yet another aspect, the puck spring 1114, also located on top of the puck base, can comprise an upper surface 1115 configured to engage a consumable product such that, when engaged with a consumable product, the upper surface of the spring is compressed towards the puck base 1102. When not engaged with a consumable product, the upper surface of the puck spring is urged away from the puck base. The puck base 1102 can be threaded onto the at least one threaded rod 1106, and the plurality of smooth rods 1104 can be inserted into the plurality of smooth openings 1108. The ends of the smooth rods can be fixed into a puck assembly housing and/or into surfaces of the dispenser. The at least one threaded rod can be attached to a motor or other rotational device, such that when the motor or other rotational device rotates, the at least one threaded rod 1106 rotates, causing the puck base 1102, and therefore the entire puck 1101 to slide on the smooth rails.

As illustrated in FIG. 13D, the package clamp 70 of the heat transfer plate 50, 250, 280 can comprise two pairs of clamp ramps 72, with one pair of clamp ramps on either end of the package clamp. In one aspect, each clamp ramp can be angled away from a corresponding clamp ramp, so that when the puck 1101 is pressed against the clamp ramps, the package clamp can be urged apart. In another aspect, the package clamp 70 can be spring loaded, such that a package clamp spring can continuously exert clamping (i.e., closing) pressure onto the package clamp. In another aspect, the plurality of smooth rods 1104 and the at least one threaded rod 1106 of the puck assembly 1100 can extend therethrough the heat transfer plate. Clamp ramps 72 can be configured to interact with the puck 1101.

In operation, when the puck is driven into a heat transfer plate 50, 250, 280, the puck base can contact a pair of clamp ramps 72 thereby spreading apart the package clamp so that a consumable product contained therein the heat transfer plate can be released. The upper surface 1115 of the puck spring 1114 can move into position therein the heat transfer plate, holding the package clamp 70 open as the puck base continues to move, eventually moving out of the heat transfer plate. A consumable product contained in a package can be placed into the heat transfer plate, either manually or automatically, engaging the upper surface of the puck spring so that the upper surface 1115 of the puck spring is moved downwardly towards the puck base 1102. As the puck spring 1114 is moved downwardly, the spring loaded package clamp is lowered, thereby exerting pressure onto the package. When the safety door 1005 is closed, the consumable product may be chilled or heated, as previously described, until the desired temperature is reached. The puck 1101 can then be driven so that the high edge of the puck ramp 1112 engages and drives the consumable product into the temperature retention dispenser tray 900 for storage and/or serving to a user. The puck can then be driven in the opposite direction so that the puck base 1102 contacts a pair of clamp ramps 72 and the cycle can begin again.

In another embodiment, illustrated in FIG. 14, the on demand consumable product heating and/or cooling dispenser can comprise an on demand heating and/or cooling system as previously described and a mobile platform 1200. The mobile platform, in one aspect can be a push cart or a trailer, although other mobile platforms are contemplated. In another aspect, the mobile platform can have a power cord and/or a generator for power. In this embodiment, the vapor compression refrigeration system 100 can be located in a bottom area 1201 of the mobile platform. In one aspect, the heat transfer plate can be located remotely from the vapor compression refrigeration system at an upper surface 1202 of the mobile platform for ease of loading of consumable products. As consumable products are chilled and/or heated to the desired temperature, they can be released from the package clamp and gravity fed to an insulated storage tray 1204 for later removal from an access door 1206 by a user.

In yet another embodiment, the on demand consumable product heating and/or cooling dispenser can comprise a heat transfer plate designed for rapid heating and/or cooling a plurality of consumable products at one time, such as, for example and without limitation, a six-pack of canned beverages. In one aspect, as illustrated in FIGS. 15A and 15B, the heat transfer plate of this embodiment can comprise at least one heat exchanger tube 1500, a multi-pack package clamp 1502, and a plurality of tube manifolds 1504. The at least one heat exchanger tube can be as described above, however, in one aspect, the at least one heat exchanger tube 1500 can be arranged so that it matches the profile of a plurality of consumable products and can circulate coolant with even distribution to each package of plurality of consumable products. The multi-pack package clamp 1502 can be substantially similar to the package clamp 70 as described above. In one aspect, however, the multi-pack package clamp can be sized and configured to selectively apply pressure on at least a portion of an outer perimeter of the plurality of consumable products. Each of the plurality of tube manifolds 1504 can, in one aspect, be a one-to-plurality manifold, so that coolant supplied from a single coolant supply line can be divided evenly into a plurality of heat exchanger tubes such that each heat exchanger tube can circulate coolant around an individual consumable product of the plurality of consumable products. In another aspect, a second tube manifold can be in fluid communication with each of the plurality of heat exchanger tubes and a single coolant return line, so that the divided coolant can be reunited before traveling through an insulated coolant return line.

In another aspect, the on demand consumable product heating and/or cooling dispenser can comprise means for queuing a plurality of consumable products at a desired temperature. In one aspect, the queuing means can comprise an insulated storage device configured for receiving a plurality of consumable products therein. For example, the mini-cooler 1400 illustrated in FIGS. 22A and 22B can be configured to receive a plurality of consumable products therein. According to one aspect, the insulated storage device and the plurality of consumable products contained therein, can be conditioned to a desired temperature by the methods and processes as described above. In another aspect, however, the insulated storage device of the dispenser comprising a queuing means can be conditioned by conventional methods. In another aspect, the queuing means can provide a more economical approach to quickly heat and/or cool a plurality of consumable products when compared to conventional methods because a smaller volume of consumable product is required to be maintained at a desired temperature, thereby results in energy savings.

For example, in one aspect, the on demand consumable product heating and/or cooling dispenser comprising a means for queuing a plurality of consumable products can comprise an insulated storage device defining an interior about ⅓ of the size of the insulated volume of a conventional dispenser. It is of course contemplated that the on demand consumable product heating and/or cooling dispenser comprising a means for queuing a plurality of consumable products can comprise an insulated storage device defining other sized interiors, such as, for example and without limitation, about 1/10, about ⅛, about ⅕, about ¼, about ½, about ⅔, and about ¾ compared to the insulated volume of a conventional dispenser.

In still another aspect, to heat and/or cool a plurality of consumable products in a dispenser comprising a means for queuing a plurality of consumable products at a desired temperature can require, for example, about 10 seconds, about 30 seconds, about 45 seconds, about 1 minute, about 2 minutes, about 5 minutes, about 10 minutes, about 20 minutes, or more. In this aspect, a plurality of consumable products can be heated and/or cooled to meet the requirements of a short sales period, without requiring the energy necessary to maintain a larger quantity of inventory of consumable products at a desired temperature.

In another aspect, the on demand consumable product heating and/or cooling dispenser of the present application can chill or heat at least one consumable product as described above. In one aspect, a user can select a temperature at which he would like a consumable product to be served that is transmitted to the control system of the on demand consumable product heating and/or cooling dispenser. The control system can then cause the heating and/or cooling system to adjust the temperature of the consumable product accordingly. In another aspect, the user can select to have a consumable product served at a temperature of between about −20 degrees Celsius to about 100 degrees Celsius. In still another aspect, the user can select to have a consumable product served at a temperature of between about 0 degrees Celsius to about 60 degrees Celsius. In another aspect, the user can select to have a consumable product served at a temperature of between about 3 degrees Celsius to about 15 degrees Celsius. In another aspect, the control system of the on demand consumable product heating and/or cooling dispenser can be pre-programmed with a temperature at which to serve the consumable product. The chilled or heated consumable product can then be served to the user by conventional means, as known in the arts, or by the use of the temperature retention dispenser tray, as described above.

In another aspect, the on demand consumable product heating and/or cooling dispenser of the present application can be installed therein a convenience or other retail store. In a retail store, in one aspect, a user can select a consumable product to consume. The consumable product can be chilled or heated as described above. In one aspect, the user can select a temperature at which he would like his consumable product to be served as described above. The chilled or heated consumable product can then be served to the by conventional means, as known in the arts, or by the use of the temperature retention dispenser tray, as described above.

In one aspect, the on demand consumable product heating and/or cooling dispenser of the present application can be installed therein a conventional vending machine 1300, as known in the arts, and illustrated in FIG. 17B. A modified vending machine 1310 having an on demand consumable product heating and/or cooling dispenser of the present application installed therein is illustrated in FIGS. 17A and 18, according to various aspects. As illustrated in FIG. 17A, in one aspect, the on demand consumable product heating and/or cooling dispenser can comprise direct heating or cooling of a consumable product, as previously described. In another aspect, and as illustrated in FIG. 18, the on demand consumable product heating and/or cooling dispenser can comprise a secondary coolant, also as previously described. Because the on demand consumable product heating and/or cooling dispenser of the present application can relatively quickly achieve the desired serving temperature of a consumable product, more inventory of consumable product can be stored at room temperature, and less consumable product needs to be stored at the desired serving temperature. Thus, less volume of storage space is necessary to maintain a sufficient quantity of consumable products at the desired serving temperature and savings in energy costs can result.

For example, in one aspect, the modified vending machine 1310 can comprise an insulated storage device defining an interior about ⅓ of the size of the insulated volume of a conventional vending machine 1300, though other size insulated storage device interiors are also contemplated. In this aspect, an uninsulated portion of the vending machine can comprise a storage area in which consumable product can be stored at an ambient temperature before being supplied to the insulated storage device. In use, a user can select a desired consumable product from a modified vending machine having an on demand consumable product heating and/or cooling dispenser installed therein. The modified vending machine 1310 can transfer the selected consumable product from the insulated storage device to the user, as known in the arts. Additionally, the modified vending machine can then supply a replacement consumable product from the uninsulated portion of the modified vending machine to the insulated storage device to begin conditioning the replacement consumable product to a desired temperature. In this aspect, as a consumable product is removed from the insulated storage device of the modified vending machine, another consumable product enters the insulated storage device in order to maintain a sufficient quantity at the desired temperature for the sales period.

In another aspect, the on demand consumable product heating and/or cooling dispenser of the present application can be installed therein a conventional reach-in dispenser 1350, as known in the arts, and illustrated in FIG. 19B. A modified reach-in dispenser 1360 having an on demand consumable product heating and/or cooling dispenser of the present application installed therein is illustrated in FIG. 19A, according to one aspect. As illustrated in FIG. 19A, because the on demand consumable product heating and cooling dispenser can relatively quickly achieve the desired serving temperature of a consumable product, more inventory of consumable product can be stored at room temperature, and less consumable product needs to be stored at the desired serving temperature. Thus, there is less volume of storage space to be maintained at the desired serving temperature and energy savings can result. For example, in one aspect, the modified reach-in dispenser can have an insulated storage device defining an interior about ⅓ of the size of the insulated volume of a conventional reach-in dispenser, though other sizes are also contemplated.

In another aspect, in various embodiments of the on demand consumable product heating and/or cooling dispenser of the present application, product can be transferred automatically from a storage area to the on demand consumable product heating and/or cooling dispenser by gravity, the puck assembly described above, and the like. Alternatively, a user, such as a consumer, a store clerk and the like can manually load consumable products into the on demand consumable product heating and/or cooling dispenser.

In other aspects, because the on demand consumable product heating and/or cooling dispenser of the present application can relatively quickly achieve the desired serving temperature of a consumable product, at least a portion of an inventory of consumable products can be stored at room temperature in various locations around a retail store or other location. As illustrated in FIGS. 20 and 21, for example, a user can select a consumable product at room temperature from a stored product area. The user can transfer the consumable product, either manually or automatically, to the on demand consumable product heating and/or cooling dispenser. In one aspect, the on demand consumable product heating and/or cooling dispenser can relatively quickly achieve the desired serving temperature of the consumable product for the consumer to enjoy. In another aspect, the consumable product transferred to the on demand consumable product heating and/or cooling dispenser can serve to “pre-load” the dispenser, as will be described more fully below. The on demand consumable product heating and/or cooling dispenser can comprise direct heating or cooling of the consumable product, as previously described. As illustrated in FIG. 21, the on demand consumable product heating and/or cooling dispenser can comprise a secondary coolant, also as previously described.

In another embodiment, the on demand consumable product heating and/or cooling dispenser can be configured as a mini-cooler unit 1400, as illustrated in FIGS. 22A and 22B, comprising an on demand cooling system 5 as described above. The mini-cooler can, for example and without limitation, be located in a convenient position in a retail store, such as on a countertop near a check-out area. In one aspect, the condenser 120 of the mini-cooler unit can be located remote to the mini-cooler, for example and without limitation, under the countertop or in a storage room. Optionally, however, it is contemplated that the condenser can be integrated into the mini-cooler unit. In still another aspect, the evaporator 140 can be installed therein the insulated storage device 20 of the mini-cooler 1400.

In one aspect, the evaporator can be built into a lower shelf 1402 of the mini-cooler unit 1400 for more efficient heat transfer to the consumable products placed therein. A supply line 11 and a return line 12 can be connected from the evaporator through the insulated storage device to the compressor 110 located outside of, and possibly remote to, the insulated storage device 20. A condenser fan 150 can be positioned to circulate air over the condenser 120, and an evaporator fan 142 can be positioned to circulate air over the evaporator. In another aspect, the evaporator fan can force cold air under the lower shelf 1402 with a predetermined amount of air coming thru a plenum 1408 formed integral to the lower shelf. In yet another aspect, the insulated storage device 20 can be sized such that the lower shelf is spaced above the insulation to allow for air flow below the lower shelf, the evaporator 140, and/or the plenum. A door 24 can provide access to the interior of the insulated storage device 20 for insertion and removal of consumable products therefrom.

In another aspect, the lower shelf of the mini-cooler can be angled such that a consumable product is not moved towards a door 1404 of the mini-cooler in an easily-accessible position unless a predetermined amount of consumable products are placed therein the mini-cooler unit. For example, the mini-unit cooler can comprise a top shelf 1406 that can be at least partially loaded with consumable products that can urge at least one consumable products of the lower shelf towards the door to an easily-accessible position. In another aspect, this can ensure that the mini-cooler is always “pre-loaded” with a predetermined amount of consumable product. This predetermined amount can, according to one aspect, be of a sufficient quantity for a sales period. It is contemplated that the mini-cooler can be pre-loaded manually by a user such as a consumer, a store clerk, and the like, or automatically. In another aspect, the lower shelf 1402 can have a holding place for the last package so that is easier for a user to access. The holding place can be, for example and without imitation, an indentation in the lower shelf.

In another aspect, the consumer product can be pre-heated or pre-chilled prior to placement in the heat transfer plate and/or the insulated storage device 20 of the present application. The pre-heating and pre-chilling can take place by conventional means, such as, for example, standard refrigeration.

In a further aspect, the control system of the on demand consumable product heating and/or cooling dispenser of the present application can be signaled by a switch when a user of the device removes a consumable product from the dispenser. The control system can then signal to activate the delivery of an additional consumable product into the heat transfer plate.

In yet another aspect, the control system can further comprise a feedback loop, as commonly known in the art. The feedback loop can be configured to control the means for cooling and/or heating a consumable product, the at least one heat transfer plate (if present), and the coolant (if present). For example and without limitation, the control system can receive information from at least one switch, at least one sensor and the like. In this example, the information received can comprise the temperature of the at least one insulated storage device, the temperature of at least one consumable product therein the at least one insulated storage device, the length of the time the cooling and/or heating means or the at least one heat transfer plate has been activated, and the like. This information can be processed by the control system and the control system can make corresponding adjustments to the operation of the on demand consumable product heating and/or cooling dispenser, if necessary. In another aspect, the at least one sensor can comprise a conventional sensor such as a thermocouple which can be attached to a conductive package holder, an infrared sensor and the like.

Although several embodiments have been disclosed in the foregoing specification, it is understood by those skilled in the art that many modifications and other embodiments will come to mind to which the application pertains, having the benefit of the teaching presented in the foregoing description and associated drawings. It is thus understood that the application is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described application, nor the claims which follow.

What is claimed is:

1. An on demand consumable product dispenser for dispensing at least one consumable product of a plurality of consumable products, the on demand consumable product dispenser comprising:
at least one uninsulated storage device defining an interior configured for storing at least one consumable product of the plurality of consumable products therein at an ambient temperature;
at least one insulated storage device defining an interior configured for receiving at least one consumable product of the plurality of consumable products therein from the at least one uninsulated storage device;
means for conditioning the interior of the at least one insulated storage device; and
a control system configured to signal the means for conditioning the interior of the at least one insulated storage device to condition the temperature of the interior of the at least one insulated storage device to a desired temperature,
wherein when a user selects at least one consumable product from the on demand consumable product dispenser, the at least one consumable product is dispensed from the at least one insulated storage device to the user, and wherein at least one consumable product of the plurality of consumable products is transferred from the at least one uninsulated storage device to the at least one insulated storage device.

2. The on demand consumable product dispenser of claim 1, wherein the means for conditioning the interior of the at least one insulated storage device comprises a vapor compression refrigeration system.

3. The on demand consumable product dispenser of claim 1, wherein the control system comprises at least one sensor configured for sensing the temperature of the at least one insulated storage device.

4. The on demand consumable product dispenser of claim 3, wherein the at least one sensor comprises an infrared sensor.

5. The on demand consumable product dispenser of claim 1, wherein conditioning the at least one insulated storage device to a desired temperature comprises cooling the at least one insulated storage device to the desired temperature.

6. The on demand consumable product dispenser of claim 1, wherein conditioning the at least one insulated storage device to a desired temperature comprises heating the at least one insulated storage device to the desired temperature.

7. An on demand consumable product dispenser for dispensing at least one consumable product contained in a package at a desired temperature, the dispenser comprising:
at least one insulated storage device defining an interior;
at least one heat transfer plate configured for receiving the at least one consumable product therein and comprising at least one heat exchanger tube;
a coolant in circulated communication with the interior of the at least one insulated storage device and the at least one heat exchanger tube;
means for conditioning the interior of the at least one insulated storage device, wherein at least a portion of the means for conditioning the interior of the at least one insulated storage device is positioned therein the interior of the at least one storage device; and
a control system configured to signal the means for conditioning the interior of the at least one insulated storage device to condition the temperature of the interior of the at least one insulated storage device to a predetermined temperature,
wherein the temperature of the at least one consumable product therein the at least one heat transfer plate is conditioned to the desired temperature.

8. The on demand consumable product dispenser of claim 7, wherein the at least one heat transfer plate is located remote to the at least one insulated storage device.

9. The on demand consumable product dispenser of claim 8, further comprising means for mixing the contents of the at least one consumable product.

10. The on demand consumable product dispenser of claim 9, wherein the means for mixing the contents of the at least one consumable product comprises rotating the consumable product periodically about at least one axis.

11. The on demand consumable product dispenser of claim 10, wherein an axis of the at least one axis is offset from the center of gravity of the at least one consumable product.

12. The on demand consumable product dispenser of claim 9, wherein the means for mixing the contents of the at least one consumable product comprises moving the consumable product periodically along at least one axis.

13. The on demand consumable product dispenser of claim 9, further comprising means for supplying the at least one consumable product to the at least one heat transfer plate.

14. The on demand consumable product dispenser of claim 13, wherein the means for supplying the at least one consumable product to the at least one heat transfer plate comprises gravity feeding the at least one consumable product to the at least one heat transfer plate.

15. The on demand consumable product dispenser of claim 13, wherein the means for supplying the at least one consumable product to the at least one heat transfer plate comprises a puck assembly configured to move the at least one consumable product to the at least one heat transfer plate.

16. The on demand consumable product dispenser of claim 9, wherein the control system comprises at least one sensor configured for sensing the temperature of the at least one consumable product.

17. The on demand consumable product dispenser of claim 16, wherein a user of the on demand consumable product dispenser selects the desired temperature.

18. The on demand consumable product dispenser of claim 17, wherein the desired temperature is in the range from about −10 to about 20 degrees Celsius.

19. The on demand consumable product dispenser of claim 16, wherein the predetermined temperature is in the range from about −50 to about −30 degrees Celsius.

20. The on demand consumable product dispenser of claim 16, wherein the at least one sensor comprises an infrared sensor.

21. The on demand consumable product dispenser of claim 7, wherein the at least one heat transfer plate further comprises a package clamp configured to selectively maintain pressure on the at least one consumable product received therein the at least one heat transfer plate.

22. The on demand consumable product dispenser of claim 21, wherein the package clamp comprises:
a bellows comprising a flexible compression bladder configured to conform to the shape of at least a portion of the exterior surface of the package of the at least one consumable product received therein the at least one heat transfer plate; and
a shell configured to hold the bellows and the at least one heat exchanger tube in a desired position.

23. An on demand consumable product dispenser for dispensing at least one consumable product at a desired temperature, the on demand consumable product dispenser comprising:
an insulated storage device defining an interior configured for receiving the at least one consumable product therein;
means for conditioning the interior of the insulated storage device;
a control system configured to signal the means for conditioning the interior of the insulated storage device to condition the temperature of the interior of the insulated storage device to the desired temperature; and
means for limiting access of a user to the at least one consumable product until a plurality of the at least one consumable product has been inserted into the insulated storage device,
wherein the temperature of the at least one consumable product therein the insulated storage device is conditioned to the desired temperature.

24. The on demand consumable product dispenser of claim 23, wherein the means for limiting access comprises at least one shelf angled such that the at least one consumable product is not moved towards an accessible position of the insulated storage device unless the predetermined amount of the at least one consumable product is placed therein the insulated storage device.

25. The on demand consumable product dispenser of claim 24, wherein the at least one shelf comprises an indentation configured for positioning the at least one consumable product in the accessible position.

26. The on demand consumable product dispenser of claim 23, further comprising means for supplying the at least one consumable product to the insulated storage device.

27. The on demand consumable product dispenser of claim 23, wherein the control system comprises at least one sensor configured for sensing the temperature of the insulated storage device.

28. The on demand consumable product dispenser of claim 27, wherein the at least one sensor comprises an infrared sensor.
